(19) United States
(12) Patent Application Publication
(10) Pub. No.: US 2010/0270452 A1
(43) Pub. Date: Oct. 28, 2010

(54) SUCKING AND HOLDING APPARATUS, SUCKING AND HOLDING METHOD, TRANSPORTING APPARATUS, AND TRANSPORTING METHOD

(75) Inventors: Saburo HOSHINO, Suwa (JP); Kenichi HARADA, Suwa (JP); Tomonori MORIYA, Chino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/763,432

(22) Filed: Apr. 20, 2010

(30) Foreign Application Priority Data
Apr. 23, 2009 (JP) 2009-104791

(51) Int. Cl. F16B 47/00

(52) U.S. Cl. 248/363

(57) ABSTRACT

A sucking and holding apparatus configured to suck and hold an object to be held by a negative pressure generating at a center portion of a swirling flow of gas generated in a swirling flow generating chamber and the gas flowing out from an end of the swirling flow generating chamber sideward, includes: a sucking and holding terminal having the swirling flow generating chamber and a sucking and holding surface having an opened suction blow-out port of the swirling flow generating chamber; an urging unit configured to apply an urging force in the direction substantially parallel to the sucking and holding surface to the object to be held located at a position which allows the same to be sucked and held by the sucking and holding terminal; and a locking unit configured to lock the object to be held against the urging force applied by the urging unit.

### BACKGROUND

1. Technical Field

The present invention relates to a sucking and holding apparatus configured to suck and hold an object to be held, a sucking and holding method for sucking and holding the object to be held, a transporting apparatus configured to transport an object to be transported while sucking and holding the same, and a transporting method for transporting the object to be transported while sucking and holding the same.

2. Related Art

In the related art, in a process of working on an work piece formed with minute structures on a fragile material like a semiconductor substrate having a plurality of semiconductor devices formed thereon, various ingenious attempts are made for a chucking method or a chucking apparatus of the work piece for preventing a worked surface of the work piece from being impaired during transport. As a method of holding the object to be held having small surfaces which can be touched for holding, a holding method using a Bernoulli's chuck configured to hold the object to be held such as the work piece without contact by applying Bernoulli's theory is used.

In JP-A-11-254369, a non-contact transporting apparatus configured to adsorb an object to be transported without contact by providing a swirling chamber in which a swirling flow of air is generated and an opposing surface which communicates with the swirling chamber and opposes the object to be transported.

In the apparatus disclosed in JP-A-11-254369, since the object to be transported is adsorbed without contact and hence a constraining force in a direction parallel to the opposing surface which opposes the object to be transported cannot be applied to the object to be transported, it is necessary to provide a constraining unit extending in the direction parallel to the opposing surface.

In JP-A-2007-67054, a Bernoulli's chuck provided with a chuck auxiliary unit including a work locking strip configured to prevent a work from sliding and detachably mounted thereto is disclosed. By configuring the chuck auxiliary unit to be demountably mouthed, it supports the works having different sizes. In JP-A-2005-142462, a wafer transporting mechanism including a friction member having a frictional surface with which the adsorbed wafer comes into abutment and being capable of preventing the wafer from moving on an adsorption surface or coming off the adsorption surface is disclosed.

JP-A-11-254369, JP-A-2007-67054, and JP-A-2005-142462 are examples of related art.

However, in the apparatus disclosed in JP-A-2007-67054, it is necessary to arrange a member corresponding to a work locking strip so as to surround the work in order to achieve the object, and hence there arises a problem that a terminal for holding the work is larger than the work. There is also a problem that a portion such as the chuck auxiliary unit must be replaced in order to support the works in the different sizes.

In the apparatus disclosed in JP-A-2005-142462, since the member to be transported such as the wafer comes into contact with a friction member, there is a problem that the object of the non-contact chuck which is implemented to avoid the contact with the surface of the member to be transported is not achieved.

### SUMMARY

An advantage of some aspects of the invention is to solve at least apart of the problems achieved by the following modes or Application Examples.

### Application Example 1

A sucking and holding apparatus according to this application is configured to suck and hold an object to be held by a negative pressure generating at a center portion of a swirling flow of gas generated in a swirling flow generating chamber and the gas flowing out from an end of the swirling flow generating chamber sideward, and includes: a sucking and holding terminal having the swirling flow generating chamber and a sucking and holding surface having an opened suction blow-out port of the swirling flow generating chamber; an urging unit configured to apply an urging force in the direction substantially parallel to the sucking and holding surface to the object to be held located at a position which allows the same to be sucked and held by the sucking and holding terminal; and a locking unit configured to lock the object to be held against the urging force applied by the urging unit.

According to the sucking and holding apparatus in this application, the object to be held can be sucked and held by the sucking and holding terminal without contact. Since the object to be held is sucked and held without contact, the object to be held can be sucked and held while preventing a surface to be sucked and held of the object to be held opposing the sucking and holding terminal from coming into contact with the sucking and holding terminal.

The urging force in the direction substantially parallel to the sucking and holding surface is applied to the object to be held by the urging unit, and the object to be held can be locked by the locking unit against the urging force. Accordingly, the surface substantially orthogonal to the surface to be sucked and held of the object to be held can be fixed to the locking unit by a force of the object to be held coming into abutment with the locking unit by the urging force. With the fixation of an end of the object to be held by the locking unit, the position of the object to be held, which is sucked and held by the sucking and holding terminal without contact, can be fixed by restraining the movement thereof in the direction substantially parallel to the sucking and holding surface.

In general, it is not preferable that a holding apparatus or the like comes into contact with the surface to be sucked and held, and hence the surface to be sucked and held is sucked and held without contact. Since the surface which comes into abutment with the locking unit is a surface substantially orthogonal to the surface to be sucked and held, the object to be held can be brought into abutment with the locking unit without bringing the locking unit into contact with the surface to be sucked and held, which is not preferable to come into contact with the holding apparatus or the like.

If the size of the object to be held is within a certain range, sucking and holding is achieved without changing the positional relationship among the sucking and holding terminal, the urging unit, and the locking unit, and hence the object to be held can be sucked and held without necessarily requiring the size of the sucking and holding apparatus to be changed according to the sizes of the objects to be held.

### Application Example 2

In the sucking and holding apparatus according to the application described above, preferably, the urging unit is a vacuum adsorption apparatus.

According to the sucking and holding apparatus, an adsorbed portion of the object to be held can be substantially fixed to the vacuum adsorption apparatus by adsorbing the object to be held by the vacuum adsorption apparatus.

### Application Example 3

In the sucking and holding apparatus according to the applications described above, preferably, the locking unit further includes a restraining member configured to restrain the movement of the object to be held in the direction substantially vertical to the sucking and holding surface.

In this sucking and holding apparatus, since the movement of the object to be held in the direction substantially vertical to the sucking and holding surface by the restraining member, position of the object to be held in the direction substantially vertical to the sucking and holding surface can be kept substantially constant within a range which allows the restraint by the restraining member even when the object to be held is not adsorbed. Excessive approach of the object to be held to the sucking and holding terminal and hence contact of the surface to be sucked and held with respect to the sucking and holding surface can be prevented.

### Application Example 4

In the sucking and holding apparatus according to the applications described above, preferably, the restraining member includes an urging and guiding bevel facing the urging unit side and being inclined so as to be capable of guiding the object to be held moving toward the urging unit in the direction substantially parallel to the sucking and holding surface to move toward the urging unit in the direction substantially vertical to the sucking and holding surface.

According to the sucking and holding apparatus, the object to be held which is moved toward the locking unit by being urged by the urging unit along the urging and guiding bevel can be guided toward the locking unit in the direction substantially vertical to the sucking and holding surface. Accordingly, the position in the locking unit where the object to be held comes into abutment with may be restrained within a range of being guided by the guiding bevel.

### Application Example 5

In the sucking and holding apparatus according to the applications described above, preferably, the locking unit restrains the movement of the object to be held in two directions substantially parallel to the sucking and holding surface and different from the direction of the urging force applied by the urging unit.

According to this sucking and holding apparatus, the movement of the object to be held in two directions substantially parallel to the sucking and holding surface and different from the direction of the urging force applied by the urging unit is restrained by the locking unit. Accordingly, the position of the object to be held in the direction substantially parallel to the sucking and holding surface can be set to a substantially constant position.

### Application Example 6

In the sucking and holding apparatus according to the applications described above, preferably, an operation control unit configured to control the sucking and holding terminal to be operated and stopped, and the urging unit to be operated and stopped is further provided.

According to this sucking and holding apparatus, by controlling the sucking and holding terminal and the urging unit to be operated and stopped by the operation control unit, the sucking and holding terminal and the urging unit can be cooperated with high efficiency to suck and hold the object to be held desirably.

### Application Example 7

In the sucking and holding apparatus according to the applications described above, preferably, the operation control unit controls the operating states of the urging unit and the sucking and holding terminal in such a manner that the sucking and holding terminal is in the operating state when the urging unit is in the operating state.

According to this sucking and holding apparatus, the operation control unit controls the operating state of the urging unit and the sucking and holding terminal in such a manner that the sucking and holding terminal is in the operating state when the urging unit is in the operating state. Accordingly, since the object to be held is sucked and held without contact while the object to be held, which is urged by the urging unit, is moved toward a position coming into abutment with the locking unit, the object to be held can be moved easily to the position of coming into abutment with the locking unit by the urging force of the urging unit.

Also, the object to be held, which is released from sucking and holding, is not supported only by the urging force of the urging unit. In general, if hold in contact does not cause a problem, the hold in contact is better because it ensures stable and easy holding. Therefore, the object to be held which is held by using the sucking and holding apparatus is held mainly by a sucking and holding force by the sucking and holding terminal, and there is a high probability that the sufficiently stable holding is difficult only by the cooperation of the urging unit and the locking unit. Since the object to be held is not supported only by the urging force of the urging unit, an event that the object to be held is held only by a method having a high probability that the sufficiently stable holding is difficult is eliminated.

### Application Example 8

In the sucking and holding apparatus according to the application described above, preferably, the locking unit further includes a sucking and guiding bevel facing toward the sucking and holding terminal and being inclined so as to be capable of guiding a portion of the object to be held moving toward the sucking and holding terminal in the direction substantially vertical to the sucking and holding surface and coming into abutment with the locking unit toward the sucking and holding terminal in the direction substantially parallel to the sucking and holding surface.

According to the sucking and holding apparatus, the sucking and guiding bevel allows the object to be held, which is moved toward the sucking and holding terminal by being applied with a suction force by the sucking and holding terminal, to be guided in such a manner that the portion of the object to be held, which comes into abutment with the locking unit, is guided toward the sucking and holding terminal in the direction substantially parallel to the sucking and holding surface. Accordingly, since the position of the portion of the object to be held, which is moved in the direction substantially vertical to the sucking and holding surface, coming into abutment with the locking unit is guided toward the sucking and holding terminal in the direction substantially parallel to the sucking and holding surface when starting sucking and holding, the portion of the object to be held, which comes into abutment of the locking unit, is prevented from overlapping and hence colliding with the locking unit in the direction substantially parallel to the sucking and holding surface. Therefore, when applying the suction force to the object to be held by the sucking and holding terminal, an allowable error of alignment of the portion of the object to be held which comes into abutment with the locking unit with respect to the portion of the locking unit where the object to be held comes into abutment can be increased in comparison with a case where the sucking and guiding bevel is not provided.

### Application Example 9

A sucking and holding method according to this application is a sucking and holding method for sucking and holding an object to be held and includes: bringing a sucking and holding surface of a sucking and holding terminal, the sucking and holding surface having a swirling flow generating chamber opening therefrom near to a surface to be sucked and held of the object to be held; starting sucking and holding to cause the sucking and holding terminal to suck and hold the object to be held without contact by a negative pressure generating at a central portion of a swirling flow of gas generated in the swirling flow generating chamber and the gas flowing out onto a surface of the sucking and holding surface continuing from an end of the swirling flow generating chamber to an opening of the swirling flow generating chamber; and applying an urging force in the direction substantially parallel to the sucking and holding surface to the object to be held which is sucked and held by the sucking and holding terminal and bringing the object to be held into abutment with a locking unit by the urging force.

According to the sucking and holding method in this application, the object to be held can be sucked and held by the sucking and holding terminal without contact. Since the object to be held is sucked and held without contact, the object to be held can be sucked and held while preventing the contact of a surface to be sucked and held of the object to be held opposing the sucking and holding terminal from coming into contact with the sucking and holding terminal.

The urging force in the direction substantially parallel to the sucking and holding surface is applied to the object to be held to bring the same into abutment with the locking unit while bringing into abutment, so that the object to be held is locked by the locking unit against the urging force. Accordingly, the surface substantially orthogonal to the surface to be sucked and held of the object to be held can be fixed to the locking unit by a force of the object to be held coming into abutment with the locking unit by the urging force. With the fixation of an end of the object to be held by the locking unit, the position of the object to be held, which is sucked and held by the sucking and holding terminal without contact, can be fixed by restraining the movement thereof in the direction substantially parallel to the sucking and holding surface.

In general, it is not preferable that a holding apparatus or the like comes into contact with the surface to be sucked and held, and hence the surface to be sucked and held is sucked and held without contact. Since the surface which comes into abutment with the locking unit is a surface substantially orthogonal to the surface to be sucked and held, the object to be held can be brought into abutment with the locking unit without bringing the locking unit into contact with the surface to be sucked and held, which is not preferable to come into contact with the holding apparatus or the like.

If the size of the object to be held is within a certain range, sucking and holding is achieved without changing the positional relationship between the sucking and holding terminal and the locking unit, and hence the object to be held can be sucked and held without necessarily requiring the size of the apparatus including the sucking and holding terminal and the locking unit to be changed according to the sizes of the objects to be held.

### Application Example 10

In the sucking and holding method according to the application described above, preferably, bringing into abutment is vacuum adsorbing using a vacuum adsorption apparatus.

According to this sucking and holding method, an adsorbed portion of the object to be held can be substantially fixed to the vacuum adsorption apparatus by adsorbing the object to be held by the vacuum adsorption apparatus.

### Application Example 11

In the sucking and holding method according to the applications described above, preferably, bringing into abutment is performed in a state in which the object to be held is sucked and held.

According to the sucking and holding method, bringing into abutment is performed in a state in which the object to be held is sucked and held. Accordingly, since the object to be held is sucked and held without contact while the object to be held, which is urged while bringing into abutment, is moved toward a position coming into abutment with the locking unit, the object to be held can be moved easily to the position of coming into abutment with the locking unit by the urging force.

Also, the object to be held, which is released from sucking and holding, is not supported only by the urging force. In general, if hold in contact does not cause a problem, the hold in contact is better because it ensures stable and easy holding. Therefore, the object to be held which is held by using the non-contact sucking and holding method is held mainly by a sucking and holding force by the sucking and holding terminal, and there is a high probability that the sufficiently stable holding is difficult only by the cooperation of the urging force and the locking unit. Since the object to be held is not supported only by the urging force, an event that the object to be held is held only by a method having a high probability that the sufficiently stable holding is difficult is eliminated.

### Application Example 12

A transporting apparatus according to this application is a transporting apparatus configured to suck and hold and transport an object to be transported without contact by a negative pressure generating at a center portion of a swirling flow of gas generated in a swirling flow generating chamber and the gas flowing out from an end of the swirling flow generating chamber sideward, including: a sucking and holding terminal having the swirling flow generating chamber and a sucking and holding surface having an opened suction blow-out port of the swirling flow generating chamber; an urging unit configured to apply an urging force in the direction substantially parallel to the sucking and holding surface to the object to be transported located at a position which allows the same to be sucked and held by the sucking and holding terminal; a locking unit configured to lock the object to be transported against the urging force applied by the urging unit; and a moving unit configured to movably support the sucking and holding terminal, the urging unit, and the locking unit.

According to the transporting apparatus in this application, the object to be transported can be sucked and held by the sucking and holding terminal without contact. Since the object to be transported is sucked and held without contact, the object to be transported can be sucked and held while preventing a surface to be sucked and held of the object to be transported opposing the sucking and holding terminal from coming into contact with the sucking and holding terminal.

The urging force in the direction substantially parallel to the sucking and holding surface is applied to the object to be transported by the urging unit, and the object to be transported can be locked by the locking unit against the urging force. Accordingly, the surface substantially orthogonal to the surface to be sucked and held of the object to be transported can be fixed to the locking unit by a force of the object to be transported coming into abutment with the locking unit by the urging force. With the fixation of an end of the object to be transported by the locking unit, the position of the object to be transported, which is sucked and held by the sucking and holding terminal without contact, can be fixed by restraining the movement thereof in the direction substantially parallel to the sucking and holding surface.

In general, it is not preferable that a holding apparatus or the like comes into contact with the surface to be sucked and held, and hence the surface to be sucked and held is sucked and held without contact. Since the surface which comes into abutment with the locking unit is a surface substantially orthogonal to the surface to be sucked and held, the object to be transported can be brought into abutment with the locking unit without bringing the locking unit into contact with the surface to be sucked and held, which is not preferable to come into contact with the holding apparatus or the like.

If the size of the object to be transported is within a certain range, sucking and holding are achieved without changing the positional relationship among the sucking and holding terminal, the urging unit, and the locking unit, and hence the object to be transported can be sucked and held and transported without necessarily requiring the size of the apparatus including the sucking and holding terminal, the urging unit, and the locking unit according to the sizes of the objects to be transported.

### Application Example 13

In the transporting apparatus according to the application described above, preferably, the urging unit is a vacuum adsorption device.

According to the transporting apparatus, an adsorbed portion of the object to be transported can be substantially fixed to the vacuum adsorption apparatus by adsorbing the object to be transported by the vacuum adsorption apparatus.

### Application Example 14

In the transporting apparatus according to the applications described above, preferably, the locking unit further includes a restraining member configured to restrain the movement of the object to be transported in the direction substantially vertical to the sucking and holding surface.

According to this transporting apparatus, since the movement of the object to be transported in the direction substantially vertical to the sucking and holding surface by the restraining member, position of the object to be transported in the direction substantially vertical to the sucking and holding surface can be kept substantially constant within a range which allows the restraint by the restraining member even when the object to be transported is not adsorbed. Excessive approach of the object to be transported to the sucking and holding terminal and hence contact of the surface to be sucked and held with respect to the sucking and holding surface can be restrained.

### Application Example 15

In the transporting apparatus according to the applications described above, preferably, the locking unit restrains the movement of the object to be transported in two directions substantially parallel to the sucking and holding surface and different from the direction of the urging force applied by the urging unit.

According to this transporting apparatus, the movement of the object to be transported in two directions substantially parallel to the sucking and holding surface and different from the direction of the urging force applied by the urging unit can be restrained by the locking unit. Accordingly, the position of the object to be transported in the direction substantially parallel to the sucking and holding surface can be set to a substantially constant position.

### Application Example 16

In the transporting apparatus according to the applications described above, preferably, an operation control unit configured to control the sucking and holding terminal to be operated and stopped and the urging unit to be operated and stopped is further provided.

According to this transporting apparatus, by controlling the sucking and holding terminal and the urging unit to be operated and stopped by the operation control unit, the sucking and holding terminal and the urging unit can be cooperated with high efficiency to suck and hold and transport the object to be transported desirably.

### Application Example 17

In the transporting apparatus according to the applications described above, preferably, the operation control unit controls the operating states of the urging unit and the sucking and holding terminal in such a manner that the sucking and holding terminal is in the operating state when the urging unit is in the operating state.

According to this transporting apparatus, the operation control unit controls the operating state of the urging unit and the sucking and holding terminal in such a manner that the sucking and holding terminal is in the operating state when the urging unit is in the operating state. Accordingly, since the object to be transported is sucked and held without contact while the object to be transported, which is urged by the urging unit, is moved toward a position coming into abutment with the locking unit, the object to be transported can be moved easily to the position of coming into abutment with the locking unit by the urging force of the urging unit.

Also, the object to be transported, which is released from sucking and holding, is not supported only by the urging force of the urging unit. In general, if hold in contact does not cause a problem, the hold in contact is better because it ensures stable and easy holding. Therefore, the object to be transported which is held by using a holding method for sucking and holding without contact is held mainly by a sucking and holding force by the sucking and holding terminal, and there is a high probability that the sufficiently stable holding is difficult only by the cooperation of the urging unit and the locking unit. Since the object to be transported is not supported only by the urging force of the urging unit, an event that the object to be transported is held only by a method having a high probability that the sufficiently stable holding is difficult is eliminated.

### Application Example 18

A transporting method according to this application is a transporting method for transporting an object to be transported from a first position to a second position by sucking and holding the object to be transported located at the first position and seating the sucked and held object to be transported to the second position, including: bringing a sucking and holding surface of a sucking and holding terminal near to a surface to be sucked and held of the object to be transported, the sucking and holding terminal having a swirling flow generating chamber and the sucking and holding surface having the swirling flow generating chamber opening therefrom; starting sucking and holding to cause the sucking and holding terminal to suck and hold the object to be transported without contact by a negative pressure generating at a central portion of a swirling flow of gas generated in the swirling flow generating chamber and the gas flowing out onto a surface of the sucking and holding surface continuing from an end of the swirling flow generating chamber to an opening of the swirling flow generating chamber; applying an urging force in the direction substantially parallel to the sucking and holding surface to the object to be transported which is sucked and held by the sucking and holding terminal and bringing the object to be transported into abutment with a locking unit by the urging force; moving the sucking and holding apparatus provided with the sucking and holding terminal and having the object to be transported sucked and held and adsorbed thereto to a position where the object to be transported faces the second position; and seating the object to be transported to the second position.

According to the transporting method in this application, the object to be transported can be sucked and held by the sucking and holding terminal without contact. Since the object to be transported is sucked and held without contact, the object to be transported can be sucked and held while preventing a surface to be sucked and held of the object to be transported opposing the sucking and holding terminal from coming into contact with the sucking and holding terminal.

The urging force in the direction substantially parallel to the sucking and holding surface is applied to the object to be transported to bring the same into abutment with the locking unit while bringing into abutment, so that the object to be transported can be locked by the locking unit against the urging force. Accordingly, the surface substantially orthogonal to the surface to be sucked and held of the object to be transported can be fixed to the locking unit by a force of the object to be transported coming into abutment with the locking unit by the urging force. With the fixation of an end of the object to be transported by the locking unit, the position of the object to be transported with respect to the sucking and holding terminal, which is sucked and held by the sucking and holding terminal without contact, can be fixed by restraining the movement thereof in the direction substantially parallel to the sucking and holding surface.

In general, it is not preferable that the holding apparatus or the like comes into contact with the surface to be sucked and held, and hence the surface to be sucked and held is sucked and held without contact. Since the surface which comes into abutment with the locking unit is a surface substantially orthogonal to a surface to be sucked and held, the object to be transported can be brought into abutment with the locking unit without bringing the locking unit into contact with the surface to be sucked and held, which is not preferable to come into contact with the holding apparatus or the like.

If the size of the object to be transported is within a certain range, sucking and holding is achieved without changing the positional relationship between the sucking and holding terminal and the locking unit, and hence the object to be transported can be sucked and held without necessarily requiring the size of the apparatus including the sucking and holding terminal and the locking unit to be changed according to the sizes of the objects to be transported.

Since the position of the object to be transported with respect to the sucking and holding terminal is fixed, the necessity of positioning of the object to be transported with respect to the second position is eliminated by moving the sucking and holding apparatus to a position where the object to be transported faces the second position, so that the object to be transported can be seated at the second position.

### Application Example 19

In the transporting method according to the application described above, bringing into abutment is vacuum adsorbing using a vacuum adsorption apparatus.

According to the transporting method, an adsorbed portion of the object to be transported can be substantially fixed to the vacuum adsorption apparatus by adsorbing the object to be transported by the vacuum adsorption apparatus.

### Application Example 20

In the transporting method according to the application described above, preferably, bringing into abutment is performed in a state in which the object to be transported is sucked and held.

According to this transporting method, bringing into abutment is performed in a state in which the object to be transported is sucked and held. Accordingly, since the object to be transported is sucked and held without contact while the object to be transported, which is urged while bringing into abutment, is moved toward a position coming into abutment with the locking unit, the object to be transported can be moved easily to the position of coming into abutment with the locking unit by the urging force.

### Application Example 21

In the transporting method according to the applications described above, preferably, seating includes: releasing adsorption for releasing the state of adsorbing the object to be transported in a state in which the sucking and holding terminal sucks and holds the object to be transported; and releasing the state in which the sucking and holding terminal sucks and holds the object to be transported.

According to this transporting method, releasing adsorption is performed in the state in which the sucking and holding terminal sucks and holds the object to be transported. Therefore, the object to be transported, which is released from sucking and holding, is not supported only by the urging force. In general, if hold in contact does not cause a problem, the hold in contact is better because it ensures stable and easy holding. Therefore, the object to be transported which is held by using the non-contact sucking and holding method is held mainly by a sucking and holding force by the sucking and holding terminal, and there is a high probability that the sufficiently stable holding is difficult only by the cooperation of the urging force and the locking unit. Since the object to be transported is not supported only by the urging force, an event that the object to be transported is held only by a method having a high probability that the sufficiently stable holding is difficult is eliminated.

### BRIEF DESCRIPTION OF THE DRAWINGS

The invention will be described with reference to the accompanying drawings wherein like numbers reference like elements.

FIG. 1A is a plan view showing an example of a SAW resonance strip.

FIG. 1B is a plan view of a resonating strip wafer formed with a plurality of SAW patterns.

FIG. 2 is an appearance perspective view showing a schematic configuration of a material feeding and removing apparatus.

FIG. 3 is a perspective view showing a structure of a suction pad.

FIG. 4 is a plan view showing a configuration of a head case.

FIG. 5A is a cross-sectional view showing a state in which the suction pads are attached to the head case.

FIG. 5B is a plan view showing the state in which the suction pads are attached to the head case viewed from the side of the suction pad.

FIG. 6 is an exploded perspective view showing a general configuration of a suction holding hand.

FIG. 7 is a flowchart showing respective steps of a resonance strip wafer transporting process.

FIGS. 8A to 8E are explanatory drawings showing positional relationships among the suction pads and an adsorption opening with respect to the resonance strip wafer in the respective steps of the resonance strip wafer transporting process.

FIG. 9 is a plan view showing the state in which the suction pads are attached to the head case viewed from the side of the suction pads.

FIG. 10 is a plan view showing the state in which the suction pads are attached to the head case viewed from the side of the suction pads.

FIG. 11 is a plan view showing the state in which the suction pads are attached to the head case viewed from the side of the suction pads.

FIG. 12A is a partial cross-sectional view showing the state in which the suction pads are attached to the head case.

FIG. 12B is a plan view showing the state in which the suction pads are attached to the head case viewed from the side of the suction pads.

### DESCRIPTION OF EXEMPLARY EMBODIMENTS

Referring now to the drawings, an embodiment of a sucking and holding method, a transporting apparatus, a transporting method, and a sucking and holding apparatus will be described. The embodiment will be described with a material feeding and removing apparatus as an example of the transporting apparatus. The material feeding and removing apparatus in the embodiment is a material feeding and removing apparatus configured to handle resonance strip wafers having a plurality of SAW (Surface Acoustic Wave) patterns formed into a cell construction which constitutes a SAW resonance strip in a process of manufacturing a SAW resonator. In the drawings to be referred to in the following description, vertical and horizontal reduction scales of members or parts and reduction scales for the respective parts may be expressed differently from actual dimensions for easy understanding of components.

### Resonance Strip Wafer

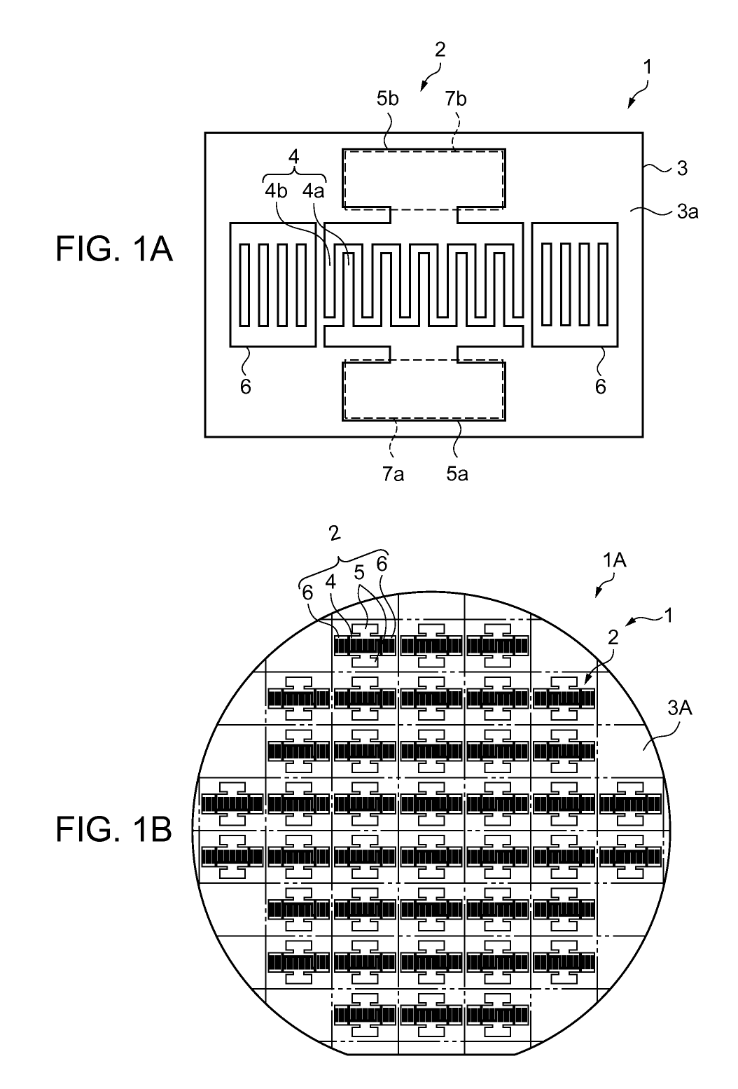

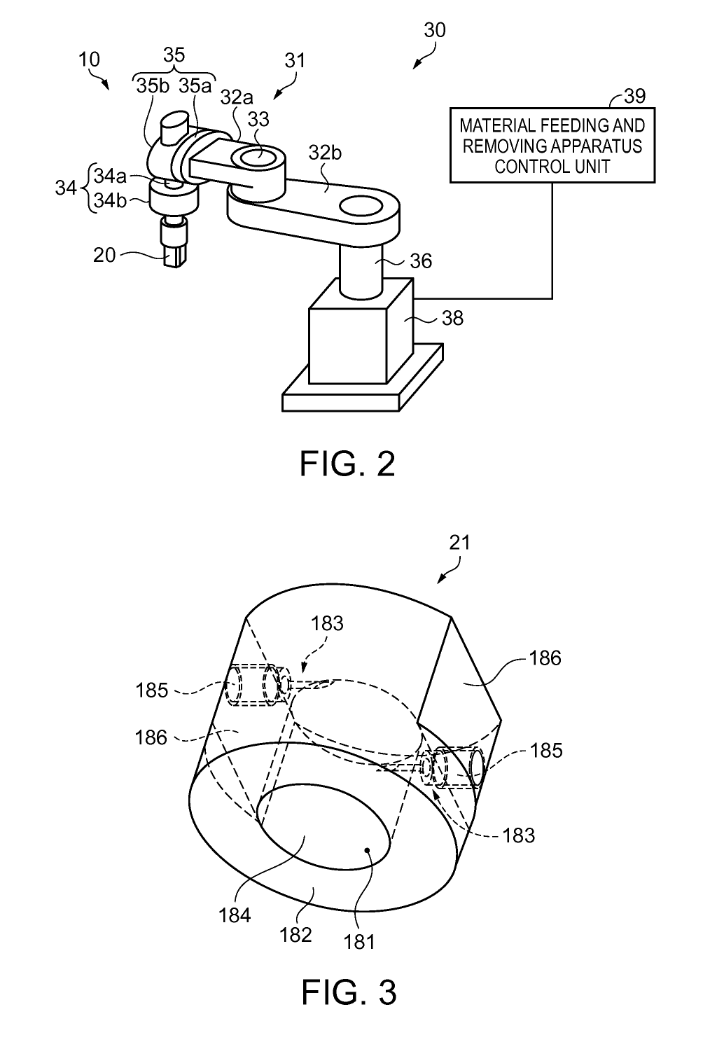

Referring firstly to FIGS. 1A and 1B, a resonance strip wafer 1A which is an example of an object to be transported, or an object to be held handled by a material feeding and removing apparatus 10 (see FIG. 2) will be described. The resonance strip wafer 1A includes SAW resonance strips 1 formed on a piezoelectric body wafer in cell pattern and the SAW resonance strips 1 are main elements which constitute a SAW resonator. FIG. 1A is a plan view showing an example of the SAW resonance strip. FIG. 1B is a plan view of the resonance strip wafer formed with the plurality of SAW patterns.

The SAW resonator is formed by encapsulating the SAW resonance strips 1 in a housing, bonding the same with an adhesive agent, and bringing the SAW resonance strips 1 and housing terminals into conduction with boding wires.

As shown in FIG. 1A, the SAW resonance strip 1 is configured with a base body (chip) which is formed by cutting a piezoelectric body such as quartz, lithium tantalate, lithium niobate into a rectangular shape. A chip 3 of the piezoelectric body in this embodiment is cut into a flat substantially rectangular shape, and is formed with an inter-digital transducer (IDT) 4 having a set of an electrode 4a and an electrode 4b at a center of a surface (main surface) 3a. Lattice shaped reflectors 6 are formed on the IDT 4 respectively on both sides in the longitudinal direction. A bonding land 5a and a bonding land 5b for conduction, each being connected respectively to the electrode 4a and the electrode 4b which constitute the IDT 4, are formed along a longitudinal edge of the chip 3. The bonding land 5a and the bonding land 5b are formed of the same material as that of the electrode 4a and the electrode 4b, and an electrical connection is achieved by wire-bonding to the bonding land 5a and the bonding land 5b. A set of the inter-digital transducer 4, the reflectors 6, the bonding land 5a, and the bonding land 5b is expressed as SAW patterns 2.

An area 7a and an area 7b shown by broken lines in FIG. 1A are areas for forming anodic oxidation resist coatings. The anodic oxidation resist coatings are configured to prevent attachment of foreign substances on electrodes by forming oxidation coatings on the surface of the electrode by anodizing the surfaces of the electrodes and protecting the electrodes with little affecting characteristics of the SAW resonance strip. The anodic oxidation resist coatings are resist coating for preventing the anodic oxidation coatings from being formed on the bonding land 5a and the bonding land 5b.

As shown in FIG. 1B, the resonance strip wafer 1A is formed with a plurality of the SAW patterns 2 on a wafer 3A of the piezoelectric body. The resonance strip wafer 1A is subjected to the anodization in a state in which the plurality of the SAW patterns 2 are formed. In this embodiment, the resonance strip wafer 1A is expressed as the resonance strip wafer 1A both before being anodized and after being anodized. When supplying the resonance strip wafer 1A to an apparatus which implements the anodization or removing the resonance strip wafer 1A formed with the anodic oxidation coating, the resonance strip wafer 1A is held by holding the surface where the SAW patterns 2 are formed or the surface of the anodic oxidation coating in many cases, so that it is necessary to use a holding method without affecting the SAW patterns 2 or the anodic oxidation coating.

### Material Feeding and Removing Apparatus

Referring now to FIG. 2, the material feeding and removing apparatus 10 will be described. FIG. 2 is an appearance perspective view showing a schematic configuration of the material feeding and removing apparatus.

As shown in FIG. 2, the material feeding and removing apparatus 10 includes a robot mechanism 30 having a sucking and holding hand 20, a material feeding and removing arm 31, and a machine base 38, and a material feeding and removing apparatus control unit 39.

The material feeding and removing arm 31 includes an arm portion 32a, an arm portion 32b, an arm joint portion 33, a direction converting mechanism 35, a hand holding mechanism 34, and an arm shaft portion 36. An end of the arm portion 32a and an end of the arm portion 32b are connected by the arm joint portion 33. An end of the arm portion 32b on the opposite side from the end connected to the arm joint portion 33 is connected to the arm shaft portion 36. The arm shaft portion 36 supports the arm portion 32b so as to be rotatable about an axis of rotation of the arm shaft portion 36. The arm portion 32b supports the arm portion 32a so as to be rotatable about an axis of rotation of the arm joint portion 33 via the arm joint portion 33. The arm portion 32a and the arm portion 32b are adjustable in angle formed therebetween by the arm joint portion 33. In other words, the material feeding and removing arm 31 is bendable and expandable at the arm joint portion 33. The direction of the axis of rotation of the arm shaft portion 36 and the direction of the axis of rotation of the arm joint portion 33 extend substantially parallel to each other. The machine base 38 supports the arm shaft portion 36 so as to be slidable in the direction of the axis of rotation of the arm shaft portion 36 and to be capable of being positioned and fixed precisely via an integrated slidably supporting mechanism (not shown).

A fixing portion 35a of the direction converting mechanism 35 is fixed to an end of the arm portion 32a on the opposite side from the end connected to the arm joint portion 33. The direction converting mechanism 35 includes the fixing portion 35a and a rotating portion 35b. The rotating portion 35b is supported by the fixing portion 35a fixed to the arm portion 32a so as to be rotatable and capable of being fixed thereto. The arm portion 32a is formed so as to extend along an axis intersecting the axis of rotation of the arm joint portion 33 and axially extending along the horizontal direction, and an axis of rotation of the rotating portion 35b is an axis extending horizontally, which substantially matches the above-described axis.

The hand holding mechanism 34 is fixed to the rotating portion 35b. The hand holding mechanism 34 includes a holding mechanism shaft 34a and a hand supporting portion 34b. The holding mechanism shaft 34a is provided on the rotating portion 35b so that an axis thereof extends upright in a direction substantially orthogonal to the axis of rotation of the rotating portion 35b. The hand supporting portion 34b is supported by the holding mechanism shaft 34a so as to be capable of rotating about the axis of the holding mechanism shaft 34a and capable of being fixed thereto. An axis of rotation of the hand supporting portion 34b resides on a plane parallel to the direction of the axis of rotation of the arm shaft portion 36 and to the direction of axis of rotation of the arm joint portion 33, so that the direction can be changed in the plane by the rotation of the rotating portion 35b with respect to the fixing portion 35a.

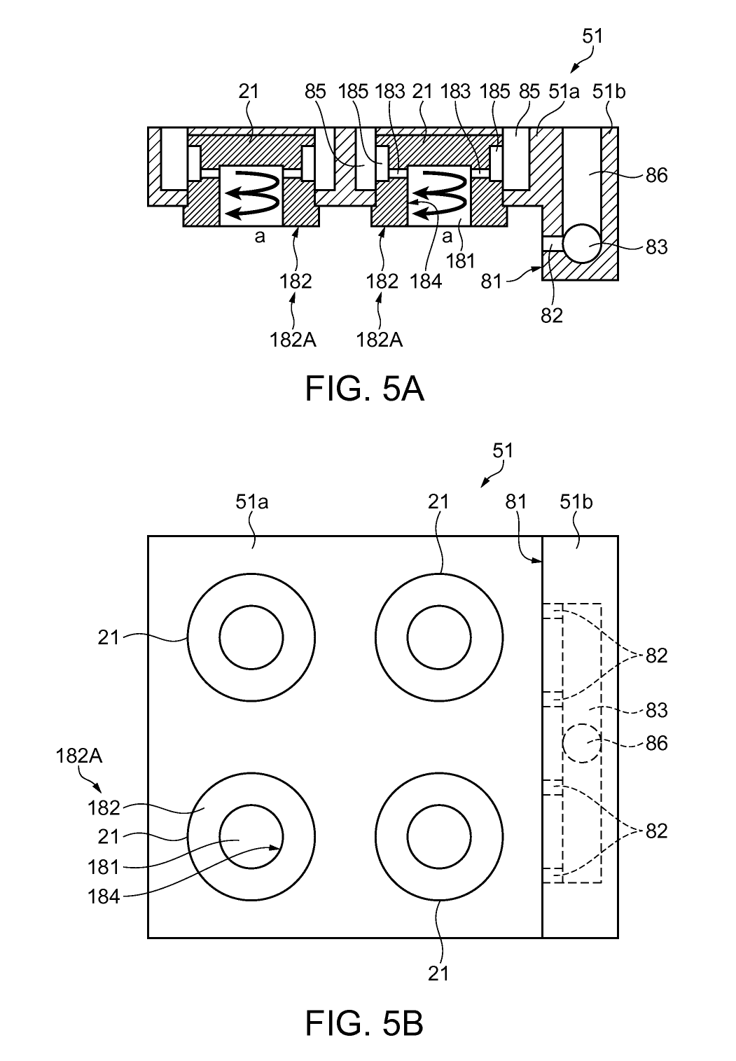

A sucking and holding hand 20 is fixed to the hand supporting portion 34b of the hand holding mechanism 34. The sucking and holding hand 20 includes four suction pads 21 (see FIG. 3), described later, and a sucking and holding surface 182A of the sucking and holding hand 20 (see FIG. 5) is formed of four sucking and holding surfaces 182 (see FIG. 3) of the four suction pads 21. The sucking and holding surface 182A of the sucking and holding hand 20 extends substantially vertical to the axis of rotation of the hand holding mechanism 34. By rotating the sucking and holding hand 20 by the hand holding mechanism 34, the sucking and holding surface 182A can be rotated in the direction of a plane parallel to the sucking and holding surface 182A to change the direction of the sucking and holding surface 182A. By changing the axis direction of the axis of rotation of the hand holding mechanism 34 by the direction converting mechanism 35, the direction of the sucking and holding surface 182A (the direction where the sucking and holding surface 182A faces) can be changed.

The material feeding and removing apparatus control unit 39 totally controls actions of the respective parts of the material feeding and removing apparatus 10 on the basis of a control program input in advance therein via a data input and output apparatus (not shown).

Subsequently, an action of the material feeding and removing apparatus 10 when the work is transported by the material feeding and removing apparatus 10 will be described.

First of all, the material feeding and removing arm 31 is rotated to a given direction by the arm shaft portion 36, and the material feeding and removing arm 31 is bent and expanded by the arm joint portion 33, so that the sucking and holding hand 20 is positioned at a given position, for example, a position which allows sucking and holding of the work. At this time, the direction of the sucking and holding surface 182A in the direction of the surface of the sucking and holding surface 182A and in the direction parallel to the direction of the surface thereof is changed by the hand holding mechanism 34 and the direction converting mechanism 35, so that the direction of the sucking and holding surface 182A is adjusted to the direction which allows the sucking and holding of the work.

Subsequently, the arm shaft portion 36 is slid in the direction of the axis of rotation thereof by a sliding support mechanism of the machine base 38 to bring the sucking and holding surface of the sucking and holding hand 20 near a distance which allows the sucking and holding of the work whereby the work is sucked and held at that position. Subsequently, the arm shaft portion 36 is slid by the sliding support mechanism of the machine base 38 to move the sucking and holding hand 20, so that the work is lifted upward.

Subsequently, the material feeding and removing arm 31 is rotated by the arm shaft portion 36 to direct the material feeding and removing arm 31 to a direction for placing the work, and then the material feeding and removing arm 31 is bent and expanded at the arm joint portion 33, so that the sucking and holding hand 20 sucking and holding the work is positioned at a position where the work faces the position to be placed. At this time, the direction of the sucking and holding surface 182A in the direction of the plane of the sucking and holding surface 182A and in the direction parallel to the direction of the plane thereof is changed by the hand holding mechanism 34 and the direction converting mechanism 35, so that the direction of the sucking and holding surface 182A is adjusted to the direction where the work faces the position to be placed.

Subsequently, the arm shaft portion 36 is slid in the direction of the axis of rotation of the arm shaft portion 36 by the sliding support mechanism of the machine base 38 to bring the work sucked and held by the sucking and holding hand 20 near a distance which allows placing thereof on a placing surface, and then the sucking and holding of the work at that position is released to drop the work on the placing surface. The work such as the resonance strip wafer 1A transported by the material feeding and removing apparatus 10 corresponds to the object to be held or the object to be transported. The robot mechanism 30 corresponds to a moving unit.

### Suction Pad

Referring now to FIG. 3, the suction pad 21 provided on the sucking and holding hand 20 will be described. The suction pad 21 is configured to hold a member without contact by sucking a member to be sucked and held and maintain a non-contact state between the member and the suction pad by applying a pressing force to the member by gas flowing out therefrom by applying Bernoulli's theory. FIG. 3 is a perspective view showing a structure of the suction pad.

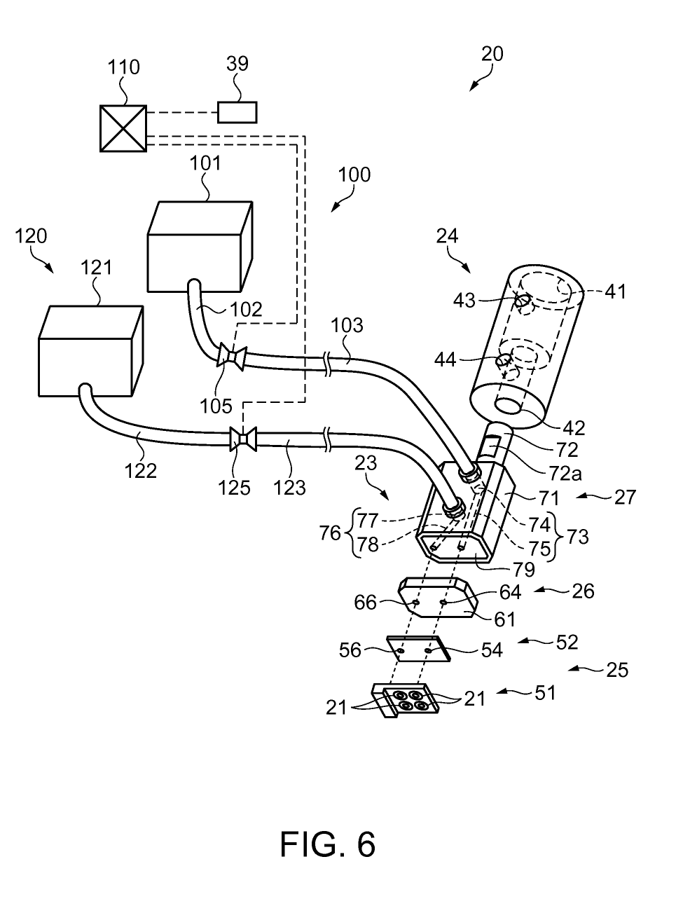

As shown in FIG. 3, the suction pad 21 includes the swirling flow generating chamber 181, a sucking and holding surface 182, a pair of gas ejection flow channels 183 and 183, and a pair of chamber flow channels 185 and 185. The swirling flow generating chamber 181 is a column-shaped recess. The sucking and holding surface 182 is an end surface having the swirling flow generating chamber 181 of the suction pad 21 opened, and is a surface continued to an end of the swirling flow generating chamber 181 on the opening side, to which a surface to be sucked and held of the member to be sucked in the state of being sucked and held faces. The gas ejection flow channel 183 opens on an inner peripheral surface 184 of the swirling flow generating chamber 181 at an end thereof, and causes compressed air to eject into the swirling flow generating chamber 181 to generate a swirling flow in the swirling flow generating chamber 181. The chamber flow channel 185 communicates with an upstream end of the each gas ejection flow channel 183, and supplies compressed air from a suction gas supply portion 100 (see FIG. 6) thereto. The compressed air supplied from the suction gas supply portion 100 flows into the pair of the chamber flow channels 185 simultaneously, and is ejected into the swirling flow generating chamber 181 through the respective gas ejection flow channels 183.

The outline of the suction pad 21 is a substantially cylindrical shape having the substantially circular sucking and holding surface 182 as an end surface thereof, and has a shape partly cut out from a midpoint of a cylinder to an end surface opposite from the sucking and holding surface 182. The cut-out portions each are a flat surface and are formed out of a pair of surfaces 186 and 186 parallel to each other. The other sides of the chamber flow channels 185 opposite from the sides communicating with the gas ejection flow channels 183 are opened through the surfaces 186.

The swirling flow generating chamber 181 is formed into a column shape closed at an end of the inner peripheral surface 184 thereof, and is formed with a pair of the gas ejection flow channels 183 on the closed side of the swirling flow generating chamber 181. The compressed air flowing into the swirling flow generating chamber 181 flows along the inner peripheral surface 184 thereof, and becomes a strong swirling flow, and soon flows out to the sides from the opening ends thereof. A negative pressure is generated at a center portion of the swirling flow according to Bernoulli's theory and the negative pressure sucks the resonance strip wafer 1A or the like.

The sucking and holding surface 182 continues to an end of the swirling flow generating chamber 181 on the opening side, and is formed into a shape substantially orthogonal to the swirling axis of the swirling flow. When the swirling flow generated in the swirling flow generating chamber 181 reaches the opened end of the swirling flow generating chamber 181, it flows out as a swirling flow from the inner peripheral side to the outer peripheral side along the sucking and holding surface 182 by its centrifugal force. A distance between the surface to be sucked and held of the member to be sucked such as the resonance strip wafer 1A and the sucking and holding surface 182 is maintained by the air flowing out from the swirling flow generating chamber 181 and flowing over the sucking and holding surface 182.

In the case of the suction pad 21 shown in FIG. 3, the swirling flow generating in the swirling flow generating chamber 181 swirls clockwise when viewed from the sucking and holding surface 182 side. When the positions of the gas ejection flow channels 183 are set to positions of plane symmetry with respect to a plane including a center axis of the swirling flow generating chamber 181, the swirling flow generating in the swirling flow generating chamber 181 swirls counterclockwise when viewed from the side of the sucking and holding surface 182. In this embodiment, any suction pads which generate the swirling flow in either swirling directions are expressed as the suction pads 21 irrespective of the direction of the swirling flow.

The shape of the suction pad 21 may be a bell mouth shape so that an opened end of the swirling flow generating chamber 181 is widened gradually, or a swirl shaped groove for maintaining the swirl flow may be formed on the sucking and holding surface 182. The suction pad 21 corresponds to a sucking and holding terminal.

### Head Case

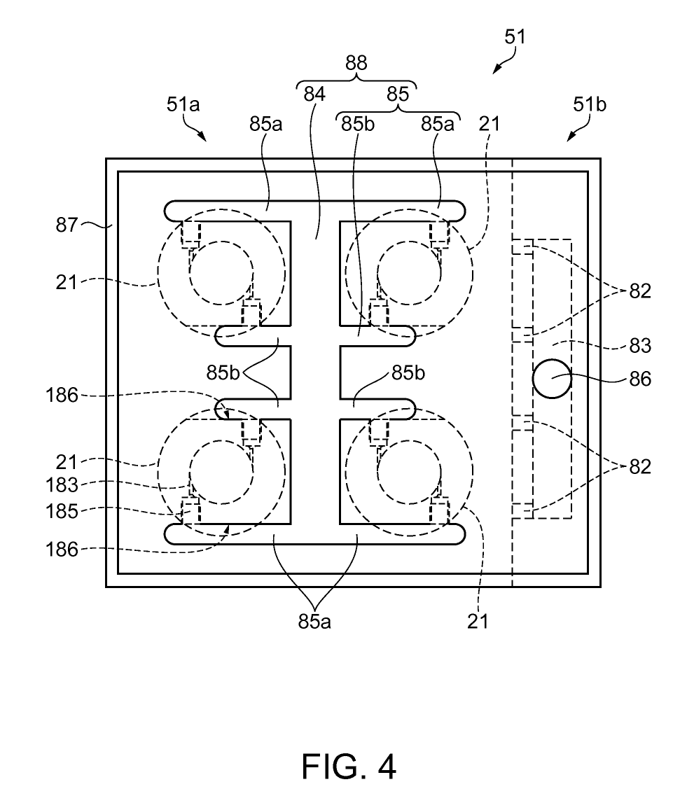

Referring now to FIG. 4 and FIGS. 5A and 5B, a head case 51 to which the suction pads 21 are fixed and constitutes a sucking and holding head 25 (see FIG. 6) will be described. FIG. 4 is a plan view showing a configuration of the head case. FIGS. 5A and 5B are drawings showing a state in which the suction pads are attached to the head case. FIG. 5A is a cross-sectional view showing the state in which the suction pads are attached to the head case, and FIG. 5B is a plan view showing the state in which the suction pads are attached to the head case when viewed from the side of the suction pads. FIG. 5A is a drawing in which a cross section substantially vertical to the sucking and holding surfaces 182 of the suction pads 21 fixed to an abutting surface 81 and a sucking and holding frame 51a and a cross-section parallel to the abutting surface 81 and substantially vertical to the sucking and holding surface 182 are combined.

As shown in FIG. 4 and FIGS. 5A and 5B, the head case 51 includes the sucking and holding frame 51a of a substantially square shape in plan view and an absorbing and holding frame 51b being a substantially rectangular shape in plan view and thicker than the sucking and holding frame 51a formed integrally to each other. The head case 51 has a substantially rectangular shape in plan view with the sucking and holding frame 51a and the absorbing and holding frame 51b arranged side by side, and a substantially L-shape in side view by the absorbing and holding frame 51b protruded from the sucking and holding frame 51a by an amount corresponding to the thickness difference.

The sucking and holding frame 51a includes the four suction pads 21 protruded downward, and holds the same so that the ends of the respective swirling flow generating chambers 181 are positioned in an identical plane. More specifically, four fixedly mounting holes are formed on the sucking and holding frame 51a in a matrix pattern. The fixedly mounting holes each include a flat surface which can fit the pair of surfaces 186 and 186 of the above-described suction pad 21 without a clearance. The each suction pad 21 is fitted into the fixedly mounting hole at the portion formed with the surfaces 186, and is fixedly bonded thereto. The four suction pads 21 are arranged in such a manner that directions of swirling of the swirling flows generated by the suction pads 21 are such that the two suction pads 21 positioned at diagonal corners generate swirling flows which swirl clockwise and the other two suction pads 21 positioned at the other diagonal corners generate swirling flows which swirl counterclockwise. A surface formed by the four sucking and holding surfaces 182 of the four suction pads 21 is designated as the sucking and holding surface 182A.

As shown in FIG. 4, a pressure blank groove 88 formed on the sucking and holding frame 51a includes a wide main pressure blank groove 84 disposed at a position dividing the four suction pads 21 into two, and one set per suction pad 21, that is, four sets in total of narrow sub pressure blank grooves 85 branched from the main pressure blank groove 84 vertically toward the respective suction pads 21.

The sets of the sub pressure blank grooves 85 each include an elongated sub pressure blank groove 85a and a short sub pressure blank groove 85b, which are disposed at positions interposing the attached suction pad 21 from both sides. In the state in which the suction pads 21 are attached to the head case 51, the elongated sub pressure blank grooves 85a and the short sub pressure blank grooves 85b are respectively in communication with the chamber flow channels 185 which are opened to the surfaces 186 of the suction pads 21. When the compressed air supplied from the suction gas supply portion 100 (see FIG. 6) described later flows from a suction gas hole 54 of a lid case 52 (see FIG. 6) described later into the respective suction pads 21 via the main pressure blank groove 84 and the respective sub pressure blank grooves 85. The compressed air flowed into the each suction pad 21 is ejected into the swirling flow generating chamber 181 and a swirling flow swirling as indicated by an arrow a shown in FIG. 5A is generated. The lid case 52 is fitted inside a protruding frame portion 87 formed along a peripheral edge of the head case 51, and hence is positioned with respect to the head case 51.

As shown in FIG. 4 and FIGS. 5A and 5B, the absorbing and holding frame 51b is formed integrally with the sucking and holding frame 51a along one side of the sucking and holding frame 51a, and the side of the absorbing and holding frame 51b where the suction pads 21 project projects with respect to the sucking and holding frame 51a. The abutting surface 81 which is a surface facing the suction pad 21 of the absorbing and holding frame 51b is formed to extend in substantially vertical to the sucking and holding surface 182 of the suction pad 21 fixed to the sucking and holding frame 51a.

The abutting surface 81 includes adsorption openings 82 at four positions. The adsorption openings 82 are formed at positions facing end surfaces of the work such as the resonance strip wafer 1A in a state of being sucked and held by the suction pads 21. Ends of the adsorption openings 82 opposite from the ends opening to the abutting surface 81 open into an adsorption pressure chamber 83. The adsorption pressure chamber 83 is a column-shaped space formed in substantially parallel to the abutting surface 81 and the sucking and holding surface 182A. An end of an adsorption pressure hole 86 which communicates with a surface with which the lid case 52 comes into abutment opens into the adsorption pressure chamber 83. An opening end of the adsorption pressure hole 86 at the surface with which the lid case 52 comes into abutment is connected to an adsorption pressure hole 56 (see FIG. 6) of the lid case 52. The adsorption pressure hole 56 is in communication with an adsorption pressure generating unit 120, described later, and atmospheric air is sucked from the adsorption openings 82 by a negative pressure formed by the adsorption pressure generating unit 120, and an adsorption force is generated. The adsorption force corresponds to an urging force. The adsorption openings 82, the adsorption pressure generating unit 120, and a route from the adsorption pressure generating unit 120 to the adsorption openings 82 correspond to an urging unit. The abutting surface 81 corresponds to a locking unit.

### Sucking and Holding Hand

Referring now to FIG. 6, a general configuration of the sucking and holding hand 20 will be described. FIG. 6 is an exploded perspective view showing a general configuration of the sucking and holding hand. The sucking and holding hand 20 corresponds to the sucking and holding apparatus.

As shown in FIG. 6, the sucking and holding hand 20 includes a plurality of the suction pads 21 (four in the drawing) configured to suck and hold the work such as the resonance strip wafer 1A, a pad holder 23 configured to hold the suction pads 21, and an apparatus mounting portion 24 configured to support the pad holder 23. The sucking and holding hand 20 includes the suction gas supply portion 100 configured to supply compressed air for non-contact holding and the adsorption pressure generating unit 120 configured to form a negative pressure for adsorption, and a sucking and holding control unit 110 configured to control the suction gas supply portion 100 and the adsorption pressure generating unit 120 and link with the material feeding and removing apparatus control unit 39.

The pad holder 23 is configured to a state in which the sucking and holding head 25 having the head case 51 described above, a case holder 26 configured to vertically support the sucking and holding head 25, and a joint member 27 configured to support the case holder 26 so as to be hung down therefrom are overlapped coaxially.

The sucking and holding head 25 includes the head case 51 and the lid case 52 described above, and the lid case 52 is fixed without clearance by being fitted inside the protruding frame portion 87 formed along the peripheral edge of the head case 51. By the lid case 52 being fitted to the head case 51, the main pressure blank groove 84 and the respective sub pressure blank grooves 85 formed on the head case 51 form a gas flow channel being communicated with the suction gas hole 54 formed on the lid case 52 and the chamber flow channel 185 formed on the suction pads 21. The adsorption pressure hole 56 formed on the lid case 52 serves as a negative pressure transmitting route which communicates with the adsorption pressure hole 86 formed on the head case 51.

The suction gas supply portion 100 includes a suction gas supply source 101, a suction air supply tube 102, a suction flow rate adjusting valve 105, and a suction air supply tube 103. The suction gas supply source 101 is an apparatus configured to pump out the compressed air such as a pneumatic pump. The suction flow rate adjusting valve 105 includes a flow channel for the compressed air and a valve unit formed at a midsection in the flow channel and being capable of opening and closing the flow channel and adjusting the flow rate of the compressed air. An end of the suction air supply tube 102 is connected to the suction gas supply source 101, the other end of the suction air supply tube 102 is connected to one of the flow channels of the suction flow rate adjusting valve 105, and one end of the suction air supply tube 103 is connected to the other flow channel of the suction flow rate adjusting valve 105, which is brought into communication with or blocked from the one flow channel by the valve unit. The other end of the suction air supply tube 103 is connected to the suction air supply flow channel 73 formed on the joint member 27 of the pad holder 23.

An opening and closing drive source of the suction flow rate adjusting valve 105 is electrically connected to the sucking and holding control unit 110, and the sucking and holding control unit 110 is electrically connected to the material feeding and removing apparatus control unit 39. The sucking and holding control unit 110 controls the opening and closing drive source according to control signals from the material feeding and removing apparatus control unit 39, and performs supply, blocking, and adjustment of the amount of supply of sucking gas by a suction flow rate adjusting valve 105.

The adsorption pressure generating unit 120 includes an adsorption pressure generating source 121, an adsorption pressure tube 122, an adsorption pressure adjusting valve 125, and an adsorption pressure tube 123. The adsorption pressure generating source 121 is an apparatus configured to suck air in a container and bring the interior of the container into a negative pressure such as a vacuum pump. The adsorption pressure adjusting valve 125 includes a gas route which transmits the negative pressure by the movement of the air and a valve unit which is formed in a midsection of the gas route and which is capable of opening and closing the gas flow channel and adjusting the flow rate of the air flowing by the negative pressure generated by the adsorption pressure generating source 121.

One end of the adsorption pressure tube 122 is connected to the adsorption pressure generating source 121, the other end of the adsorption pressure tube 122 is connected to one of the gas routes of the adsorption pressure adjusting valve 125, and one end of the adsorption pressure tube 123 is connected to the other gas route, which is brought into communication with or blocked from the gas route by the valve unit. The other end of the adsorption pressure tube 123 is connected to an adsorption pressure channel 76 formed on the joint member 27 of the pad holder 23. The adsorption pressure generating unit 120 is connected to the adsorption pressure hole 86 formed on the head case 51.

The opening and closing drive source of the adsorption pressure adjusting valve 125 is electrically connected to the sucking and holding control unit 110, and the sucking and holding control unit 110 is electrically connected to the material feeding and removing apparatus control unit 39. The sucking and holding control unit 110 controls the opening and closing drive source according to the control signals from the material feeding and removing apparatus control unit 39, and performs supply, blocking, and adjustment of the flow rate of gas generated by a negative pressure by the adsorption pressure adjusting valve 125. The sucking and holding control unit 110 corresponds to an operation control unit.

The apparatus mounting portion 24 of the sucking and holding hand 20 is formed into a substantially cylindrical shape, and a large diameter attachment hole 41 is formed in the interior of an upper half portion and a small diameter mounting hole 42 is formed in the interior of a lower half portion, respectively. The attachment hole 41 and the mounting hole 42 are disposed coaxially, and the attachment hole 41 functions as a portion for mounting the sucking and holding hand 20 to the hand holding mechanism 34 of the robot mechanism 30, and a mounting portion 72 of the joint member 27 is inserted and mounted into the mounting hole 42.

The hand holding mechanism 34 and the apparatus mounting portion 24 are fixed to each other by fixing the portion of the hand holding mechanism 34 fitted into the attachment hole 41 with a fixing screw screwed into an upper screw hole 43. The apparatus mounting portion 24 and the joint member 27 are fixed to each other by fixing the mounting portion 72 of the joint member 27 fitted into the mounting hole 42 with a fixing screw screwed into a lower screw hole 44.

The joint member 27 of the pad holder 23 includes the mounting portion 72 and a vertically provided portion 71. The column-shaped mounting portion 72, which substantially matches in direction of the center axis thereof with the direction of the center axis of the substantially rectangular column shape of the vertically provided portion 71, is provided upright on a top surface at one end of the vertically provided portion 71 having the substantially rectangular column shape. Part of the side surface of the substantially column-shaped mounting portion 72 is cut out to form a flat portion 72a with which the fixing screw screwed into the lower screw hole 44 described above comes into abutment. The mounting portion 72 is fitted to the mounting hole 42 of the apparatus mounting portion 24, and the fixing screw is screwed into the lower screw hole 44, so that the joint member 27 is mounted on the apparatus mounting portion 24. A base seat 79 having a substantially rectangular shape chamfered at corners is vertically provided on an end surface of the vertically provided portion 71 on the opposite side from the end surface where the mounting portion 72 is provided so as to project therefrom. A depression of the case holder 26 is fitted to the base seat 79 for fixedly positioning the same.

A suction air supply flow channel 73 and the adsorption pressure channel 76 are formed in the interior of the vertically provided portion 71. The suction air supply flow channel 73 is a substantially “L”-shaped flow channel, which is connected to the suction air supply tube 103 and continues to the swirling flow generating chambers 181 of the suction pad 21. The suction air supply flow channel 73 includes a lateral flow channel 74 and a vertical flow channel 75. The lateral flow channel 74 opens from a side surface of the substantially rectangular-column-shaped vertically provided portion 71 and is formed substantially vertically to the side surface, and the suction air supply tube 103 is connected to the opening via a joint. The vertical flow channel 75 opens at one end thereof at a position on a surface of the base seat 79 at a central side and is formed substantially vertically to the surface, and the opening is connected to a suction gas hole 64 of the case holder 26 fitted to the base seat 79. Ends of the lateral flow channel 74 and the vertical flow channel 75 on the opposite side from the opening ends are joined to each other and form a substantially “L”-shaped suction air supply flow channel 73.

The adsorption pressure channel 76 is a substantially “L”-shaped pressure transmitting channel, which is connected to the adsorption pressure tube 123 and continues to the adsorption openings 82 of the head case 51. The adsorption pressure channel 76 includes a lateral pressure channel 77 and a vertical pressure channel 78. The lateral pressure channel 77 opens from a side surface of the substantially rectangular-column-shaped vertically provided portion 71 and is formed substantially vertically to the side surface, and the adsorption pressure tube 123 is connected to the opening. The vertical flow channel 78 is formed at one end thereof near one of short sides of the substantially rectangular surface of the base seat 79 so as to be opened therefrom, and the opening is connected to an adsorption pressure hole 66 of the case holder 26 fitted to the base seat 79. Ends of the lateral pressure channel 77 and the vertical pressure channel 78 on the opposite side from the opening ends are joined to each other and form a substantially “L”-shaped adsorption pressure channel 76.

The case holder 26 is formed with a depressed seating portion where the base seat 79 of the vertically provided portion 71 is fitted on a holder body 61, which is formed into a substantially rectangular thick plate chamfered at four corners. With the base seat 79 formed at an end surface of the vertically provided portion 71 (joint member 27) engaged with and fixed to the seating portion, the case holder 26 is suspended and supported by the vertically provided portion 71. In the state in which the case holder 26 is suspended and supported by the vertically provided portion 71, the suction gas hole 64 or the adsorption pressure hole 66 is formed at a portion of the holder body 61 which corresponds to the opening of the suction air supply flow channel 73 or the opening of the adsorption pressure channel 76.

The sucking and holding head 25 described above is hung and supported by the case holder 26. In a state in which the sucking and holding head 25 is hung and supported by the case holder 26, the suction gas hole 64 formed on the case holder 26 on the central side communicates with the suction gas hole 54 formed on the lid case 52 on the central side. The adsorption pressure hole 66 formed near one of the short sides of the case holder 26 communicates with the adsorption pressure hole 56 of the lid case 52.

### Transport

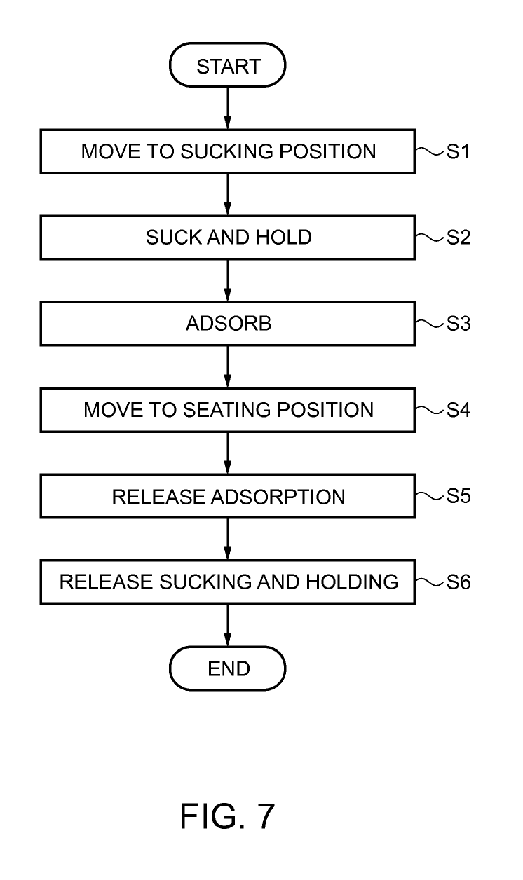

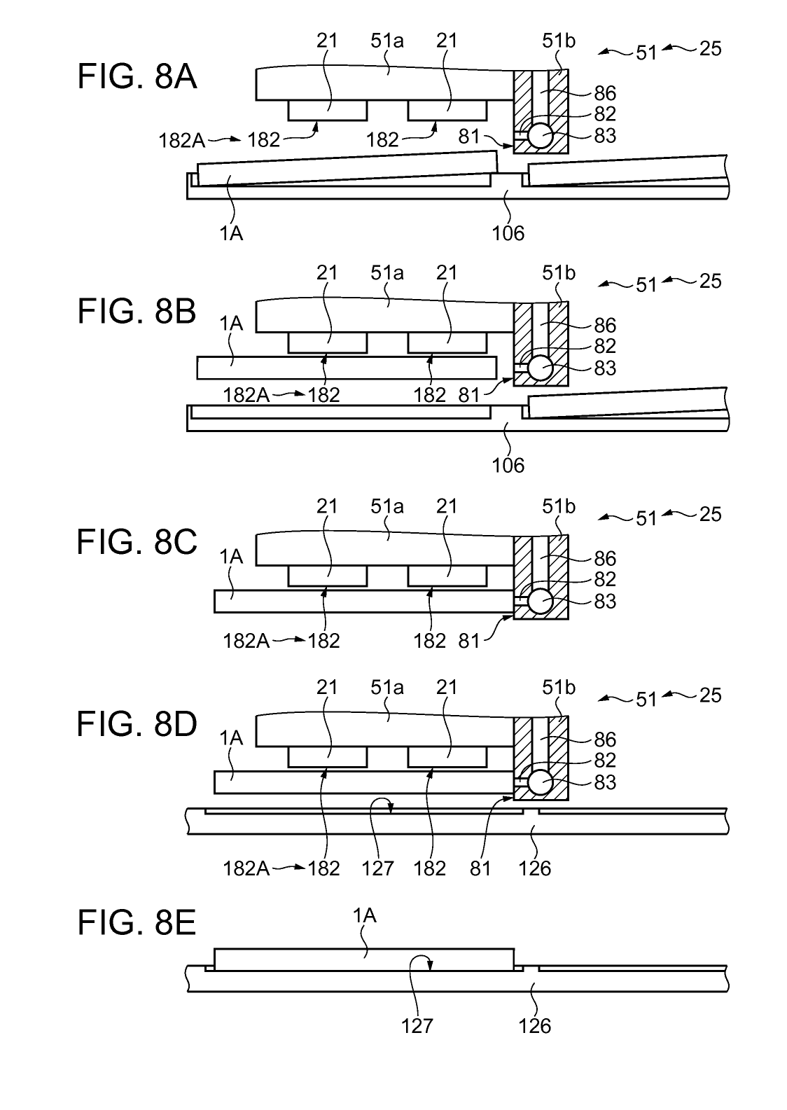

Referring now to FIG. 7 and FIGS. 8A to 8E, a transport and alignment process for the sucking and holding resonance strip wafers 1A placed on a transporting palette 106 by the sucking and holding hand 20 of the material feeding and removing apparatus 10 and causing the same to be seated and aligned on the working palette 126 will be described. FIG. 7 is a flowchart showing respective steps of a resonance strip wafer transporting process. FIGS. 8A to 8E are explanatory drawings showing positional relationships among the suction pad and an adsorption opening with respect to the resonance strip wafer in the respective steps of the process of transporting the resonance strip wafer. The position for placing the resonance strip wafer 1A on the transporting palette 106 corresponds to a first position. A predetermined seating position on the working palette 126 corresponds to a second position.

First of all, in Step S1 in FIG. 7, the sucking and holding hand 20 is moved by the robot mechanism 30 to move the sucking and holding head 25 of the sucking and holding hand 20 to a suction position which allows the sucking and holding head 25 to suck and hold the resonance strip wafer 1A placed on the transporting palette 106 as shown in FIG. 8A.

As described later, a substantial alignment of the resonance strip wafer 1A with respect to the sucking and holding head 25 is performed in a post process. Therefore, the positional accuracy of the sucking and holding head 25 with respect to the position of the resonance strip wafer 1A in Step S1 may be a degree which allows the four suction pads 21 to keep the resonance strip wafer 1A into a sucked and held state.

In Step S2 in FIG. 7, the resonance strip wafer 1A is sucked and held by the sucking and holding hand 20 without contact as shown in FIG. 8B. This step is performed by opening the suction flow rate adjusting valve 105, feeding the compressed air from the suction gas supply source 101 to the suction pads 21, and generating a negative pressure in the swirling flow generating chambers 181.

Subsequently, in Step S3 in FIG. 7, an end surface of the resonance strip wafer 1A sucked and held by the suction pads 21 is caused to be adsorbed by the adsorption openings 82 as shown in FIG. 8C.

More specifically, the interior of the adsorption pressure tube 122 connected to the adsorption pressure generating source 121 is brought into the negative pressure by the adsorption pressure generating source 121 first. Then, the adsorption pressure adjusting valve 125 is opened, so that the adsorption pressure tube 122 connected to the adsorption pressure generating source 121, the adsorption pressure adjusting valve 125, the adsorption pressure tube 123, the adsorption pressure channel 76 of the joint member 27, the adsorption pressure hole 66 of the case holder 26, the adsorption pressure hole 56 of the lid case 52, the adsorption pressure hole 86 and the adsorption pressure chamber 83 of the head case 51, and the adsorption openings 82 of the head case 51 form a communicated space. Since the negative pressure is formed in the interior of the adsorption pressure tube 122 by the adsorption pressure generating source 121, there is a negative pressure in communicated space, so that atmospheric air flows into the space from the adsorption openings 82 at the opened end and the resonance strip wafer 1A is adsorbed.

The end surface of the resonance strip wafer 1A adsorbed to the adsorption openings 82 comes into abutment with the abutting surface 81, and is locked to the abutting surface 81 by the adsorption force applied from the adsorption openings 82. The resonance strip wafer 1A is brought into abutment at the end surface thereof with the abutting surface 81, and hence is positioned so that the end surface thereof comes into abutment with the abutting surface 81 with respect to the sucking and holding hand 20 (sucking and holding head 25). The resonance strip wafer 1A is locked at the end surface thereof with the abutting surface 81 by the adsorption force applied by the adsorption openings 82, thereby being restrained from moving in the direction parallel to the sucking and holding surface 182A.

Subsequently, in Step S4 in FIG. 7, the sucking and holding hand 20 (sucking and holding head 25) sucking and holding the resonance strip wafer 1A is moved by the robot mechanism 30, and the resonance strip wafer 1A is moved to a position facing to a predetermined seating area 127 on a working palette 126 as shown in FIG. 8D. The resonance strip wafer 1A is brought into abutment at the end surface thereof with the abutting surface 81, and hence is positioned so that the end surface thereof comes into abutment with the abutting surface 81 with respect to the sucking and holding head 25. Therefore, the sucking and holding head 25 sucking and holding the resonance strip wafer 1A is moved to a position where the held resonance strip wafer 1A can face the predetermined seating area 127, so that the resonance strip wafer 1A can be moved to a position facing the seating area 127.

Subsequently, in Step S5 in FIG. 7, the adsorption pressure adjusting valve 125 is closed to block the connection between the adsorption pressure generating source 121 and the adsorption openings 82, and resolve the negative pressure at the adsorption openings 82, so that the adsorption by the adsorption openings 82 is released.

Subsequently, in Step S6 in FIG. 7, the suction flow rate adjusting valve 105 is closed to stop the supply of compressed air with respect to the suction pad 21, so that the sucking and holding state is released. By releasing the sucked and held state, the resonance strip wafer 1A is seated on the seating area 127 of the working palette 126 as shown in FIG. 8E.

By implementing Step S6, the steps of transporting one resonance strip wafer 1A from the transporting palette 106, and causing the same to be seated on the seating area 127 of the working palette 126 are finished. By repeating this process, the resonance strip wafers 1A placed on the transporting palette 106 are transported, and are aligned on the working palette 126.

### Other Head Case 1

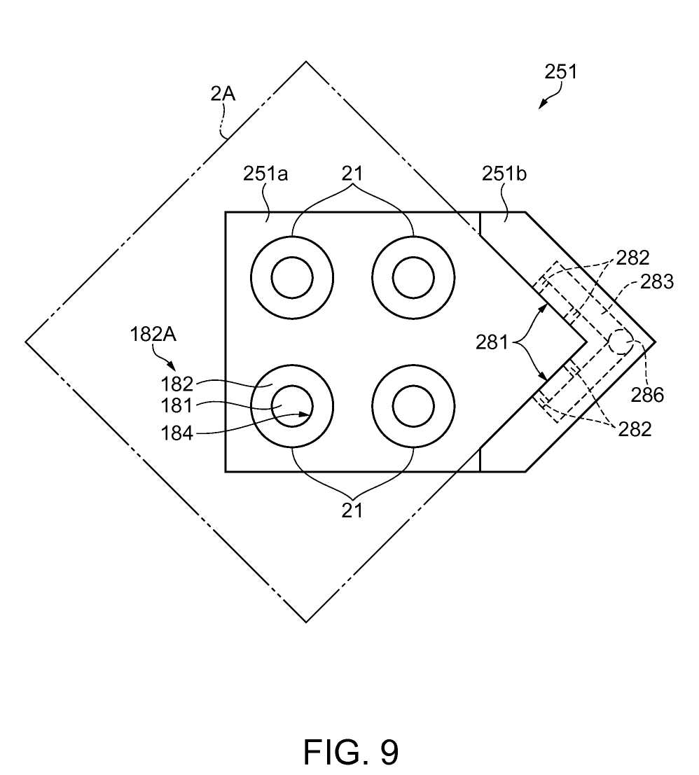

Referring now to FIG. 9, a head case 251 having a configuration different from that of the head case 51 described above will be described. FIG. 9 is a plan view showing the state in which the suction pads are attached to the head case viewed from the side of the suction pads.

As shown in FIG. 9, the head case 251 includes a sucking and holding frame 251a and an absorbing and holding frame 251b thicker than the sucking and holding frame 251a formed integrally to each other. The head case 251 is different from the head case 51 in that the shape of the absorbing and holding frame 251b is different from that of the absorbing and holding frame 51b of the head case 51.

The sucking and holding frame 251a has the same configuration as the sucking and holding frame 51a, and is different in the shape in plan view from the sucking and holding frame 51a corresponding to the shape of the absorbing and holding frame 251b. The shape of the sucking and holding frame 251a in plan view has a pentagonal shape including a substantially square shape and a right-angled isosceles triangle attached on one side thereof. Although not shown in the drawing, the configuration of the pressure blank groove or the mounting structure of the suction pad 21 are substantially the same as the sucking and holding frame 51a. The four suction pads 21 are fixed to the sucking and holding frame 251a, and four sucking and holding surfaces 182 of the four suction pads 21 constitute the sucking and holding surface 182A. The work such as the resonance strip wafer 2A can be sucked and held by the sucking and holding surface 182A by operating the suction pads 21. The resonance strip wafer 2A shown by double-dashed chain line in FIG. 9 is a wafer like the resonance strip wafer 1A, and has a substantially rectangular shape in plan view.

The absorbing and holding frame 251b is integrally connected to the sucking and holding frame 251a at two sides of a portion of the right-angled isosceles triangle of the pentagonal sucking and holding frame 251a, which interposes a right angle. The absorbing and holding frame 251b projects from the sucking and holding frame 251a on the side of the surface where the suction pads 21 project from the sucking and holding frame 251a. Portions of the absorbing and holding frame 251b projecting from the sucking and holding frame 251a and facing the sucking and holding frame 251a side are expressed as abutting surfaces 281. The abutting surfaces 281 are formed substantially vertical to the sucking and holding surface 182A. The absorbing and holding frame 251b includes the two abutting surfaces 281 and the two abutting surfaces 281 are substantially orthogonal to each other.

The abutting surfaces 281 are formed respectively with two adsorption openings 282, that is, four adsorption openings 282 are formed in total. The adsorption openings 282 are formed at positions facing end surfaces of the work such as the resonance strip wafer 2A in a state of being sucked and held by the suction pads 21.

Ends of the adsorption openings 282 opposite from the ends opening to the abutting surface 281 open into an adsorption pressure chamber 283. The adsorption pressure chamber 283 includes two column-shaped spaces formed in substantially parallel to the abutting surface 281 and the sucking and holding surface 182A, and the two column-shaped spaces are orthogonal to each other at one end of each to form an integral space. An end of an adsorption pressure channel 286 which communicates with a surface (the surface opposite from the side shown in FIG. 9) with which a lid case like the lid case 52 abuts is opened at a portion where the two column-shaped spaces intersect. An opening end of an adsorption pressure channel 286 at the surface with which the lid case comes into abutment is connected to an adsorption pressure hole of the lid case. The adsorption pressure hole is in communication with the adsorption pressure generating unit 120 and atmospheric air is sucked from the adsorption openings 282 by the negative pressure formed by the adsorption pressure generating unit 120, and an adsorption force is generated. The adsorption force corresponds to an urging force.

The resonance strip wafer 2A adsorbed to the adsorption openings 282 comes into abutment with the abutting surfaces 281 respectively at two sides. Since the positions in the vertical two directions of the resonance strip wafer 2A are defined respectively by the two abutting surfaces 281 in the direction parallel to the sucking and holding surface 182A, the resonance strip wafer 2A is positioned at a constant position with respect to the head case 251. The abutting surfaces 281 correspond to the locking unit.

### Other Head Case 2

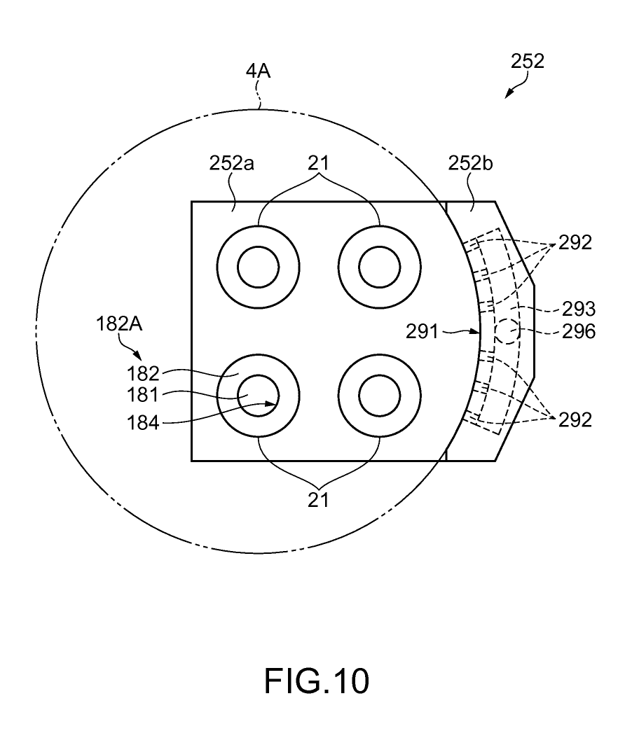

Referring now to FIG. 10, a head case 252 having a configuration different from that of the head case 51 and the head case 251 described above will be described. FIG. 10 is a plan view showing the state in which the suction pad is attached to the head case viewed from the side of the suction pad.

As shown in FIG. 10, the head case 252 includes a sucking and holding frame 252a and an adsorbing and holding frame 252b thicker than the sucking and holding frame 252a formed integrally to each other. The head case 252 is different from the head case 51 in that the shape of the absorbing and holding frame 252b is different from that of the absorbing and holding frame 51b of the head case 51.

The sucking and holding frame 252a has the same configuration as the sucking and holding frame 51a, and is different in the shape in plan view from the sucking and holding frame 51a corresponding to the shape of the absorbing and holding frame 252b. The shape of the sucking and holding frame 252a in plan view has a shape including a substantially square shape and a circular segment shape attached to one side thereof, and a chord of the arc has the same length as the one side. Although not shown in the drawing, the configuration of the pressure blank groove 88 or the mounting structure of the suction pad 21 are substantially the same as the sucking and holding frame 51a. The four suction pads 21 are fixed to the sucking and holding frame 252a, and four sucking and holding surfaces 182 of the four suction pads 21 constitute the sucking and holding surface 182A. The work such as a resonance strip wafer 4A can be sucked and held by the sucking and holding surface 182A by operating the suction pads 21. The resonance strip wafer 4A shown by double-dashed chain line in FIG. 10 is a wafer like the resonance strip wafer 1A, and has a substantially circular shape in plan view.

The absorbing and holding frame 252b is connected integrally with the sucking and holding frame 252a at an arcuate portion of the circular segment. The absorbing and holding frame 252b projects from the sucking and holding frame 252a on the side of the surface where the suction pads 21 project from the sucking and holding frame 252a. Portions of the absorbing and holding frame 252b projecting from the sucking and holding frame 252a and facing the sucking and holding frame 252a side are expressed as an abutting surface 291. The abutting surfaces 291 are formed substantially vertical to the sucking and holding surface 182A. The abutting surface 291 is formed along an arc at a boundary portion between the sucking and holding frame 252a and the absorbing and holding frame 252b, and the shape in plan view thereof viewed from the substantially vertical direction to the sucking and holding surface 182A has the arcuate shape.

The abutting surfaces 291 are formed with six adsorption openings 292, that is, six adsorption openings 292 are formed. The adsorption openings 292 are formed at positions facing end surfaces of the work such as the resonance strip wafer 4A in a state of being sucked and held by the suction pads 21.

Ends of the adsorption openings 292 opposite from the ends opening to the abutting surface 291 open into an adsorption pressure chamber 293. The adsorption pressure chamber 293 has an arcuate shape formed substantially parallel to the abutting surface 291 and the sucking and holding surface 182A, and is a space having a cross section in the direction substantially orthogonal to the arc in a substantially circular shape. An end of an adsorption pressure channel 296 which communicates with a surface (the surface on the opposite side from the surface shown in FIG. 10) with which a lid case like the lid case 52 abuts is opened into the adsorption pressure chamber 293 at a substantially center portion of the arc. An opening end of the adsorption pressure channel 296 at the surface with which the lid case comes into abutment is connected to an adsorption pressure hole of the lid case. The adsorption pressure hole is in communication with the adsorption pressure generating unit 120 and atmospheric air is sucked from the adsorption opening 292 by the negative pressure formed by the adsorption pressure generating unit 120, and an adsorption force is generated. The adsorption force corresponds to an urging force.

The resonance strip wafer 4A adsorbed to the adsorption openings 292 comes into abutment with the abutting surface 291 along an outline of the arcuate shape. Since the positions in two directions of the resonance strip wafer 4A are defined by the abutment of the arc of the outline thereof to the arcuate abutting surface 291 having an arc shape in the direction parallel to the sucking and holding surface 182A, the resonance strip wafer 4A is positioned at a constant position with respect to the head case 252. The abutting surface 291 correspond to the locking unit.

### Other Head Case 3

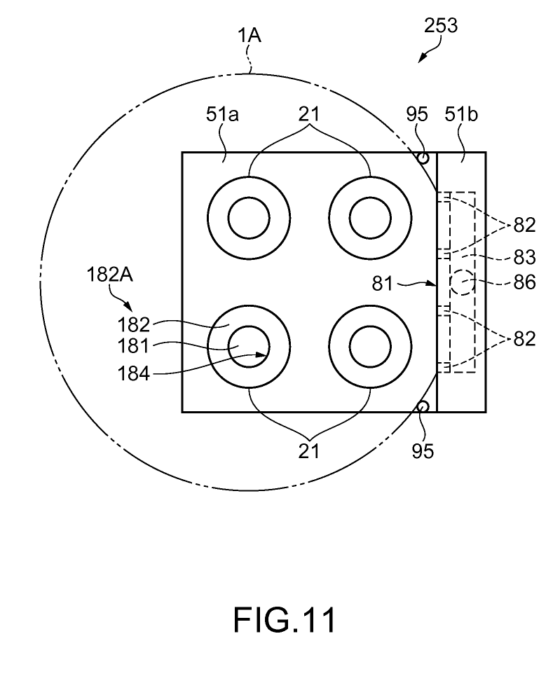

Referring now to FIG. 11, a head case 253 having a configuration different from that of the head case 51 and so on described above will be described. FIG. 11 is a plan view showing the state in which the suction pad is attached to the head case viewed from the side of the suction pad.

As shown in FIG. 11, the head case 253 includes the sucking and holding frame 51a and the absorbing and holding frame 51b, which are the same as those of the head case 51, formed integrally to each other. The head case 253 is different from the head case 51 in having two position restricting projections 95.

The position restricting projections 95 are provided upright on the surface of the sucking and holding frame 51a from which the suction pads 21 project. The two position restricting projections 95 are respectively disposed near the end of the abutting surface 81.

The resonance strip wafer 1A adsorbed to the adsorption openings 82 comes into contact with the column-shaped side surfaces of the position restricting projections 95 at the arcuate-shaped outline thereof, and the position is restricted between the two position restricting projections 95. The resonance strip wafer 1A comes into abutment with the abutting surface 81 in the direction parallel to the sucking and holding surface 182A, and is restricted between the position restricting projections 95 and is positioned at a constant position with respect to the head case 253.

By adjusting the size or the position of the position restricting projections, works of various shapes and sizes are supported.

### Other Head Case 4

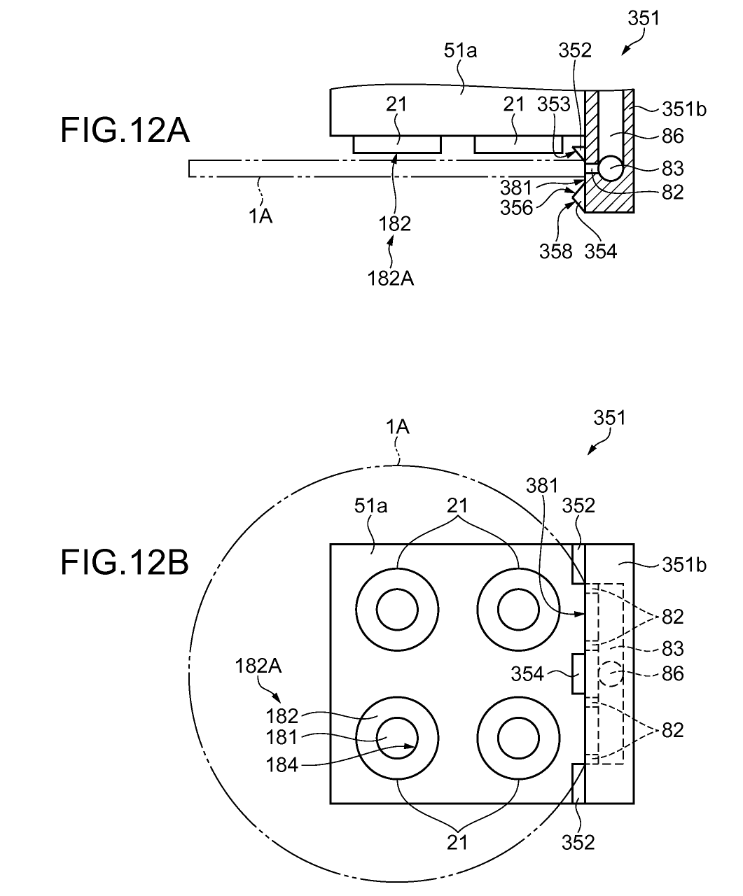

Referring now to FIGS. 12A and 12B, a head case 351 having a configuration different from that of the head case 51 and so on described above will be described. FIGS. 12A and 12B are drawings showing a state in which the suction pads are attached to the head case. FIG. 12A is a partial cross-sectional view showing a state in which the suction pads are attached to the head case, and FIG. 12B is a plan view showing a state in which the suction pads are attached to the head case when viewed from the side of the suction pads.

As shown in FIGS. 12A and 12B, the head case 351 includes an absorbing and holding frame 351b and the sucking and holding frame 51a which is the same as that of the head case 51 formed integrally to each other. The absorbing and holding frame 351b is different from the absorbing and holding frame 51b of the head case 51 in having guiding projections 352 and a guiding projection 354.

In the same manner as the absorbing and holding frame 51b, the absorbing and holding frame 351b includes an abutting surface 381 substantially vertical to the sucking and holding surface 182A, and the abutting surface 381 includes the four adsorption openings 82 opened at positions facing an end surface of the work such as the resonance strip wafer 1A in a state of being sucked and held by the suction pads 21 of the sucking and holding frame 51a. The abutting surface 381 corresponds to the locking unit.

The guiding projections 352 are provided upright on the side closer to the sucking and holding frame 51a than the opening of the adsorption openings 82 on the abutting surface 381. The guiding projections 352 each include an adsorption guiding bevel 353 facing the side of the adsorption openings 82. The adsorption guiding bevel 353 is inclined in such a manner that the farther from the abutting surface 381 in the direction vertical to the abutting surface 381 (the direction parallel to the sucking and holding surface 182A), the farther it becomes from the adsorption openings 82 in the direction vertical to the sucking and holding surface 182A (the direction parallel to the abutting surface 381). When the work such as the resonance strip wafer 1A comes into abutment with the adsorption guiding bevels 353 when moving toward the adsorption openings 82 in the direction vertical to the abutting surface 381 by the adsorption force from the adsorption openings 82, the work such as the resonance strip wafer 1A moves along the adsorption guiding bevels 353, and hence is guided toward the adsorption openings 82 in the direction vertical to the sucking and holding surface 182A. The guiding projections 352 correspond to the restricting members, and the adsorption guiding bevels 353 correspond to urging and guiding bevels.

The guiding projections 354 are provided upright on the side farther the sucking and holding frame 51a than the opening of the adsorption openings 82 on the abutting surface 381. The guiding projections 354 each include an adsorption guiding bevel 356 facing the side of the adsorption openings 82. The adsorption guiding bevel 356 is inclined in such a manner that the farther from the abutting surface 381 in the direction vertical to the abutting surface 381 with respect to the portion connected with the abutting surface 381 (the direction parallel to the sucking and holding surface 182A), the farther it becomes from the adsorption openings 82 in the direction vertical to the sucking and holding surface 182A (the direction parallel to the abutting surface 381). When the work such as the resonance strip wafer 1A comes into abutment with the adsorption guiding bevels 356 when moving toward the adsorption openings 82 in the direction vertical to the abutting surface 381 by the adsorption force from the adsorption openings 82, the work such as the resonance strip wafer 1A moves along the adsorption guiding bevels 356, and hence is guided toward the adsorption openings 82 in the direction vertical to the sucking and holding surface 182A. The guiding projections 354 correspond to the restricting members, and the adsorption guiding bevels 356 correspond to the urging and guiding bevels.

The guiding projection 354 also includes a sucking and guiding surface 358 facing the side of the sucking and holding frame 51a in the direction vertical to the abutting surface 381. The sucking and guiding surface 358 is inclined in such a manner that the farther from the sucking and holding surface 182A in the direction vertical to the sucking and holding surface 182A (the direction parallel to the abutting surface 381), the farther it becomes from the suction pad 21 of the sucking and holding frame 51a in the direction vertical to the abutting surface 381 (the direction parallel to the sucking and holding surface 182A).

When the work such as the resonance strip wafer 1A comes into abutment with the sucking and guiding surface 358 when moving toward the sucking and holding surface 182A in the direction vertical to the sucking and holding surface 182A by a suction force from the suction pad 21 of the sucking and holding frame 51a, the work such as the resonance strip wafer 1A moves along the sucking and guiding surface 358, and hence is guided toward the suction pad 21 of the sucking and holding frame 51a in the direction parallel to the sucking and holding surface 182A. The sucking and guiding surface 358 corresponds to the sucking and guiding bevel.

Description of the effects according to the embodiments will be described below. According to the embodiments, the following effects are obtained.

(1) The sucking and holding hand 20 includes the suction pads 21 and the suction gas supply portion 100 configured to supply the compressed air for non-contact holding to the suction pads 21. Accordingly, the work such as the resonance strip wafer 1A can be sucked and held without contact using the sucking and holding hand 20.

(2) The sucking and holding hand 20 includes, in addition to the suction pads 21 and the suction gas supply portion 100, the adsorption openings 82, the adsorption pressure generating unit 120 configured to form the negative pressure for adsorption, and the abutting surface 81 with which the adsorbed work or the like comes into abutment. Accordingly, the end surface of the work such as the resonance strip wafer 1A which is sucked and held without contact can be adsorbed and brought into abutment with the abutting surface 81 using the sucking and holding hand 20. By the abutment with the abutting surface 81, an end of the work can be fixed to the abutting surface 81 by the abutment force.

(3) An end of the work can be fixed to the abutting surface 81 by the adsorption force by the adsorption openings 82. Therefore, even when a gravitational center of the work and points of action of a sucking and holding force by the suction pads 21 are misaligned, the sucked and held work can be prevented from being inclined. Accordingly, even the large work with respect to the size of the sucking and holding hand 20 can be sucked and held.

(4) An end of the work can be fixed to the abutting surface 81 by the adsorption force by the adsorption openings 82. Accordingly, the position of the work in the direction vertical to the abutting surface 81 can be positioned at a constant position with respect to the head case 51 of the sucking and holding hand 20.

(5) The adsorption force by the adsorption openings 82 acts on the end surface of the resonance strip wafer 1A, and the end surface comes into abutment with the abutting surface 81. Accordingly, contact with a surface which is formed with the SAW pattern 2 or the like and hence is preferably kept free from contact is avoided, and fixation is achieved only by bringing a portion which is affected relatively little by the contact into contact.

(6) The suction gas supply portion 100 includes the suction gas supply source 101 and the suction flow rate adjusting valve 105. By the provision of the suction flow rate adjusting valve 105, switching between the supply and the block of the compressed air with respect to the suction pads 21 can be performed quickly and reliably.

(7) The adsorption pressure generating unit 120 includes the adsorption pressure generating source 121 and the adsorption pressure adjusting valve 125. By the provision of the adsorption pressure adjusting valve 125, switching between the negative pressure state of the adsorption openings 82 and the normal atmospheric pressure state can be performed quickly and reliably.

Although the preferable embodiments have been described with reference to the attached drawings thus far, the preferable embodiments are not limited to those described above. The embodiments may be variously modified without departing the scope of the invention as a matter of course, and may be implemented as follows.

### Modification 1

In the embodiments described above, the material feeding and removing apparatus 10 as the transporting apparatus having the sucking and holding unit includes the sucking and holding hand 20, the material feeding and removing arm 31, the machine base 38, and the material feeding and removing apparatus control unit 39. However, provision of the apparatus configured to hold the sucking and holding hand 20 or the like and move the same such as the material feeding and removing arm 31 or the machine base 38 in the transporting apparatus is not necessarily required. For example, an apparatus configured to support the sucking and holding hand 20 with a simple supporting member and move the supporting member manually is also applicable.

### Modification 2

In the embodiments described above, the adsorption pressure generating unit 120 is provided with the adsorption pressure generating source 121 and the adsorption pressure adjusting valve 125 configured to open and close the transmitting route at a negative pressure. However, provision of the apparatus configured to open and close the transmitting route at the negative pressure is not necessarily required. The operation of transmission and blocking of the negative pressure may be achieved by putting the negative pressure generating source such as the adsorption pressure generating source 121 to be operated or stopped.

### Modification 3

In the embodiments described above, the sucking and holding hand 20 includes the four suction pads 21. However, the number of the suction pads provided on the sucking and holding unit is not limited to four. The number of the suction pads provided on the sucking and holding unit is not limited as long as an adequate sucking and holding force corresponding to the size and the weight of the object to be held or the object to be transported is achieved.

### Modification 4

In the embodiments described above, the resonance strip wafer 1A formed with a plurality of SAW patterns 2 has been described as the object to be held or the object to be transported. However, the object to be held and the object to be transported are not limited to be a material for forming transducers. The sucking and holding and transport may be achieved desirably by using above-described sucking and holding method, the transporting apparatus, or the transporting method as long as it is a member preferable to be held without contact and is an object to be held without contact when being held.

### Modification 5

In the embodiments described above, the resonance strip wafer 1A as the object to be held or the object to be transported has a substantially circular shape having partly a linear portion. However, the object to be held or the object to be transported does not have to have the substantially circular shape. The shapes of the object to be held and the object to be transported may be of any shape as long as it is a shape having a sucked and held surface, to which the suction force corresponding to its weight can be applied.

### Modification 6

In the embodiments described above, the gas supplied to the suction pads 21 is air. However, the sucking and holding gas is not limited to the air. The sucking and holding method, the transporting apparatus, the transporting method, and the sucking and holding apparatus may be applied irrespective of the type of the gas as long as it can drive the sucking and holding unit. For example, it can also be applied in an environment in which inertia gas is filled for preventing corrosion or the like.

### Modification 7

In the embodiments described above, the sucking and holding control unit 110 as the operation control unit controls the suction flow rate adjusting valve 105 or the adsorption pressure adjusting valve 125 to supply and block the suction gas or transmit and block the negative pressure. However, the operation control unit does not have to be the control unit provided on the transporting apparatus or the sucking and holding apparatus. The operation control unit may be an operation and stop switch for controlling the manual operation.

### Modification 8

In the embodiments described above, the suction gas supply portion 100 is provided with the suction gas supply source 101 and the suction flow rate adjusting valve 105 configured to open and close the flow channel of the compressed air. However, provision of the apparatus configured to open and close the flow channel or adjust the flow rate of the gas is not necessarily required. The operation to supply and stop the suction gas or the adjustment of the supply amount is achieved by the supply source of the suction gas.

### Modification 9

In the embodiments described above, the suction apparatus including the adsorption pressure generating unit 120 and the adsorption openings 82 as the urging units generates an urging force by the atmospheric pressure. However, the source of the urging force does not necessarily have to be the atmospheric pressure. The urging unit may be, for example, an apparatus configured to suck by a magnetic force.

The entire disclosure of Japanese Patent Application No: 2009-104791, filed Apr. 23, 2009 is expressly incorporated by reference herein.

What is claimed is:

1. A sucking and holding apparatus configured to suck and hold an object to be held by a negative pressure generating at a center portion of a swirling flow of gas generated in a swirling flow generating chamber and the gas flowing out from an end of the swirling flow generating chamber sideward, comprising:
a sucking and holding terminal having the swirling flow generating chamber and a sucking and holding surface having an opened suction blow-out port of the swirling flow generating chamber;
an urging unit configured to apply an urging force in the direction substantially parallel to the sucking and holding surface to the object to be held located at a position which allows the same to be sucked and held by the sucking and holding terminal; and
a locking unit configured to lock the object to be held against the urging force applied by the urging unit.

2. The sucking and holding apparatus according to claim 1, wherein the urging unit is a vacuum adsorption apparatus.

3. The sucking and holding apparatus according to claim 1, wherein the locking unit further includes a restraining member configured to restrain the movement of the object to be held in the direction substantially vertical to the sucking and holding surface.

4. The sucking and holding apparatus according to claim 3, wherein the restraining member includes an urging and guiding bevel facing the urging unit side and being inclined so as to be capable of guiding the object to be held moving toward the urging unit in the direction substantially parallel to the sucking and holding surface to move toward the urging unit in the direction substantially vertical to the sucking and holding surface.

5. The sucking and holding apparatus according to claim 1, wherein the locking unit restrains the movement of the object to be held in two directions substantially parallel to the sucking and holding surface and different from the direction of the urging force applied by the urging unit.

6. The sucking and holding apparatus according to claim 1, further comprising an operation control unit configured to control the sucking and holding terminal to be operated and stopped, and the urging unit to be operated and stopped.

7. The sucking and holding apparatus according to claim 6, wherein the operation control unit controls the operating states of the urging unit and the sucking and holding terminal in such a manner that the sucking and holding terminal is in the operating state when the urging unit is in the operating state.

8. The sucking and holding apparatus according to claim 1, wherein the locking unit further includes a sucking and guiding bevel facing toward the sucking and holding terminal and being inclined so as to be capable of guiding a portion of the object to be held moving toward the sucking and holding terminal in the direction substantially vertical to the sucking and holding surface and coming into abutment with the locking unit toward the sucking and holding terminal in the direction substantially parallel to the sucking and holding surface.

9. A sucking and holding method for sucking and holding an object to be held comprising:
bringing a sucking and holding surface of a sucking and holding terminal, the sucking and holding surface having a swirling flow generating chamber opening therefrom near to a surface to be sucked and held of the object to be held;
starting sucking and holding to cause the sucking and holding terminal to suck and hold the object to be held without contact by a negative pressure generated at a central portion of a swirling flow of gas generated in the swirling flow generating chamber and the gas flowing out onto a surface of the sucking and holding surface continuing from an end of the swirling flow generating chamber to an opening of the swirling flow generating chamber; and
applying an urging force in the direction substantially parallel to the sucking and holding surface to the object to be held which is sucked and held by the sucking and holding terminal and bringing the object to be held into abutment with a locking unit by the urging force.

10. The sucking and holding method according to claim 9, wherein bringing into abutment is vacuum adsorbing using a vacuum adsorption apparatus.

11. The sucking and holding method according to claim 9, wherein bringing into abutment is performed in a state in which the object to be held is sucked and held.

12. A transporting apparatus configured to suck and hold and transport an object to be transported without contact by a negative pressure generating at a center portion of a swirling flow of gas generated in a swirling flow generating chamber and the gas flowing out from an end of the swirling flow generating chamber sideward, comprising:
a sucking and holding terminal having the swirling flow generating chamber and a sucking and holding surface having an opened suction blow-out port of the swirling flow generating chamber;
an urging unit configured to apply an urging force in the direction substantially parallel to the sucking and holding surface to the object to be transported located at a position which allows the same to be sucked and held by the sucking and holding terminal;
a locking unit configured to lock the object to be transported against the urging force applied by the urging unit; and
a moving unit configured to movably support the sucking and holding terminal, the urging unit, and the locking unit.

13. The transporting apparatus according to claim 12, wherein the urging unit is a vacuum adsorption device.

14. The transporting apparatus according to claim 12, wherein the locking unit further includes a restraining member configured to restrain the movement of the object to be transported in the direction substantially vertical to the sucking and holding surface.

15. The transporting apparatus according to claim 12, wherein the locking unit restrains the movement of the object to be transported in two directions substantially parallel to the sucking and holding surface and different from the direction of the urging force applied by the urging unit.

16. The transporting apparatus according to claim 12, further comprising an operation control unit configured to control the sucking and holding terminal to be operated and stopped and the urging unit to be operated and stopped.

17. The transporting apparatus according to claim 16, wherein the operation control unit controls the operating states of the urging unit and the sucking and holding terminal in such a manner that the sucking and holding terminal is in the operating state when the urging unit is in the operating state.
